(19) United States
(12) Patent Application Publication
(10) Pub. No.: US 2016/0298061 A1
(43) Pub. Date: Oct. 13, 2016

(54) DETERGENT OR CLEANING AGENT COMPRISING A DRY, WATER-SOLUBLE FOAM LAYER

(71) Applicant: Henkel AG & Co. KGaA, Duesseldorf (DE)

(72) Inventors: Christian Reichert, Weingarten (DE); Peter Schmiedel, Duesseldorf (DE); Tobias Segler, Duesseldorf (DE); Matthias Sunder, Duesseldorf (DE); Uwe Trebbe, Duesseldorf (DE); Frank Meier, Duesseldorf (DE)

(73) Assignee: Henkel AG & Co. KGaA, Duesseldorf (DE)

(21) Appl. No.: 15/180,542

(22) Filed: Jun. 13, 2016

Related U.S. Application Data
(63) Continuation of application No. PCT/EP2014/077406, filed on Dec. 11, 2014.

(30) Foreign Application Priority Data
Dec. 18, 2013 (DE) 10 2013 226 509.3

(51) Int. Cl. C11D 17/04

(52) U.S. Cl. CPC C11D 17/042

(57) ABSTRACT

The invention relates to detergent or cleaning agent products comprising: a) at least one first substantially water-soluble layer; b) at least one first chamber; and c) at least one second substantially water-soluble layer. The at least one first chamber contains a unit dose of a liquid and/or solid detergent or cleaning agent. Also disclosed are methods for manufacturing detergent or cleaning agent products as well as the use thereof.

### FIELD OF THE INVENTION

The present invention generally relates to detergent or cleaning agent products comprising at least one water-soluble layer, which comprises a substantially dry, substantially water-soluble foam, to a process for preparing these products and to use thereof.

### BACKGROUND OF THE INVENTION

Detergents and cleaning agents are known in many different forms. Thus, the consumer is familiar with solid, for example, tablet-shaped or granular detergents and liquid or gel-like cleaners for hard surfaces. Agents such as rinsing agents or hand soaps are also known, which, although present in the packaging in the liquid state, are converted into a foam by the consumer prior to use by means of a foaming dosing device and are dispensed directly into the rinsing water or into the palm of the hand (for dishwashing detergents see WO 2007/003302 A1, for example). Some bathroom cleaners are also sprayed onto the surfaces to be treated directly as foam using special foaming spray nozzles. Shaving foam is foamed by the consumer only as it is dosed.

Foams are thought to have special properties by consumers, such as a high active substance activity and an associated performance of the product. At the same time, the consumer expects softness, gentleness, care and protection from a foam, but also improved stain removal performance.

There is a need, however, to provide consumers with a water-soluble foam-based product of which the foam is in the solid state so as to bypass the step of foam preparation, which is inconvenient to the consumer, since the consumer may come into contact undesirably with the foam as said foam is produced.

WO 2010/077650 A1, US 2011/0028373 A1, US 2011/0028374 A1, and US 2011/0023240 A1 describe detergents and cleaning agents which consist of water-soluble foams.

However, it has proven to be disadvantageous to provide detergent and cleaning agent products which consist exclusively of water-soluble foam.

Firstly, because of the porous structure, the actual active substance density is not very high, and therefore a much larger volume is required compared to liquid detergents and cleaning agents in order to provide the same active substance amounts. This is disadvantageous when it comes to the transport of the product, since the costs of the shipment of container goods is calculated based on the volume and not the weight. In addition, the products must be produced in a relatively large format, which is therefore cumbersome for the consumer, in order to provide the active substances required for a detergent or cleaning operation in sufficient quantity.

Thus, there is the problem of producing practical detergent and cleaning agent products which have the advantages of foam-based detergents and cleaning agents.

A detergent or cleaning agent product comprising: a) at least one first layer, which is a flexible, substantially water-soluble, substantially dry foam layer, b) at least one first chamber, and c) at least one second substantially water-soluble layer, wherein the at least one first chamber contains a unit dose of a liquid and/or solid detergent or cleaning agent, solves the problems described above.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A detergent or cleaning agent product comprising: at least one first layer, which is a flexible, substantially dry, substantially water-soluble foam layer; at least one first chamber; and at least one second substantially water-soluble layer, wherein the at least one first chamber contains a unit dose of a liquid and/or solid detergent or cleaning agent, wherein the at least one second layer is preferably a substantially water-soluble film.

A method for producing a detergent or cleaning agent product, comprising the following steps: providing at least one first layer, which is a flexible, substantially water-soluble, substantially dry foam layer; providing at least one second substantially water-soluble layer; and forming at least one first chamber, which contains a unit dose of a liquid and/or solid detergent or cleaning agent, wherein the second substantially water-soluble layer is preferably a substantially water-soluble film.

### BRIEF DESCRIPTION OF THE DRAWINGS

The present invention will hereinafter be described in conjunction with the following drawing figures, wherein like numerals denote like elements, and

FIG. 1 shows a cross section through an embodiment of the detergent or cleaning agent product (10) of the present invention;

FIG. 2 shows a cross section through an embodiment of the detergent or cleaning agent product (10) of the present invention;

FIG. 3 shows a cross section through an embodiment of the detergent or cleaning agent product (10) of the present invention;

FIG. 4 shows a plot of force over path for determining the modulus of elasticity of a substantially dry, substantially water-soluble foam; and

FIG. 5 shows the standard throat test which is used in accordance with European Standard 71-1.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

### SUMMARY OF THE INVENTION

In a first aspect, the present invention relates to detergent or cleaning agent products comprising: a) at least one first layer, which is a flexible, substantially dry, substantially water-soluble foam layer, b) at least one first chamber, and c) at least one second substantially water-soluble layer, wherein the at least one first chamber contains a unit dose of a liquid and/or solid detergent or cleaning agent.

In various embodiments of the detergent or cleaning agent product the at least one second layer is a substantially water-soluble film.

In some embodiments of the detergent or cleaning agent product
a) the at least one chamber is arranged between the at least one first and the at least one second layer and is formed by the at least one first and the at least one second layer, or
b) the at least one first chamber is formed by a first structure comprising the at least one first layer, or
c) the at least one first chamber is formed by a first structure which comprises the at least one second layer.

In more specific embodiments of the detergent or cleaning agent product in case b) the at least one second layer surrounds the first structure completely or in case c) the at least one first layer surrounds the first structure completely.

In further embodiments of the detergent or cleaning agent product in case b) the at least one second layer and the first structure are in direct contact with each other or in case c) the at least one first layer and the first structure are in direct contact with each other.

In some embodiments of the detergent or cleaning agent product in cases b) and c) the first structure comprises a third layer which is a substantially water-soluble film, which in case b) forms the at least one first chamber with the at least one first layer and in case c) forms the at least one first chamber with the at least one second layer or in case b), the first structure consists of the at least one first layer or in case c) the first structure consists of the at least one second layer.

In various embodiments of the detergent or cleaning agent product the at least one second layer is transparent and is formed such that the content of the at least one first chamber is visible from the outside through the at least one second layer.

In some embodiments of the detergent or cleaning agent product
a) the flexible, substantially dry, substantially water-soluble foam layer, constituting the at least one first layer, comprises foamed substantially water-soluble polyvinyl alcohol and/or foamed substantially water-soluble polyvinylpyrrolidone and/or foamed substantially water-soluble copolymers thereof, and/or
b) the at least one second substantially water-soluble layer is a substantially water-soluble polymer film and/or
c) the at least one second substantially water-soluble layer is a flexible layer and/or
d) the at least one second substantially water-soluble layer consists of a substantially water-soluble polymer film, consisting substantially of substantially water-soluble polyvinyl alcohol and/or substantially water-soluble polyvinylpyrrolidone, and/or substantially water-soluble copolymers thereof.

In various embodiments of the detergent or cleaning agent product, the flexible, substantially water-soluble, substantially dry foam layer of the at least one first layer comprises at least one constituent which is selected from the group consisting of a surfactant, softener, perfume, perfume delivery system, dye, preservative, bittern, filler, excipient, special polymer and a functional additive, wherein the surfactant is selected in particular from the group consisting of nonionic, cationic, anionic, and amphoteric surfactants and mixtures thereof, the softener is selected in particular from the group consisting of glycerol and polyols, the excipient is selected in particular from the group consisting of thickeners and salts, the special polymer is selected in particular from the group consisting of acrylic acid (co)polymer, cationic hydroxymethyl cellulose, carboxymethyl cellulose and HPMC, and the functional additive is selected in particular from the group consisting of silicone oils, bentonites, perfume capsules, enzymes and bleaches, wherein the bleach is selected in particular from the group of peroxy acids and amides of various peroxy acids, for example phthalimido peroxy hexanoic acid (PAP).

In further embodiments of the detergent or cleaning agent product the substantially water-soluble polyvinyl alcohol and/or the substantially water-soluble polyvinylpyrrolidone and/or the substantially water-soluble copolymers thereof of the at least one first layer and/or the at least one second layer have an average chain length of 600 to 12,000, in particular 1,000 to 8,000.

In some embodiments of the detergent or cleaning agent product the detergent or cleaning agent product is substantially water-soluble.

In particular embodiments of the detergent or cleaning agent product the detergent or cleaning agent product comprises at least one second chamber comprising a unit dose of a solid and/or liquid detergent or cleaning agent.

In various embodiments of the detergent or cleaning agent product the at least one second chamber is configured similarly to the at least one first chamber.

In particular embodiments of the detergent or cleaning agent product the at least one first chamber contains a unit dose of a liquid detergent or cleaning agent.

In some embodiments of the detergent or cleaning agent product the at least one second chamber contains a unit dose of a solid detergent or cleaning agent.

In particular embodiments the detergent or cleaning agent product has a single chamber. In further embodiments the detergent or cleaning agent product has two chambers. In some embodiments the detergent or cleaning agent product has three chambers.

The chambers are preferably constructed in accordance with the same pattern.

In various embodiments of the detergent or cleaning agent product the flexible, substantially dry, substantially water-soluble foam constituting the at least one first layer has
a) an average cell diameter of 10 to about 1,200 μm, preferably 200 to about 1,000 μm,
b) a modulus of elasticity determined at 25° C. by tensile tests in the linear range of 0.001 and 100 MPa, and/or
c) a density from about 0.03 g/cm³ to about 0.30 g/cm³, in particular from about 0.04 g/cm³ to about 0.08 g/cm³, more particularly from about 0.05 g/cm³ to about 0.06 g/cm³.

In a second aspect, the present invention relates to a method for producing a detergent or cleaning agent product comprising the following steps:
providing at least one first layer, which is a flexible, substantially water-soluble, substantially dry foam layer,
providing at least one second substantially water-soluble layer,
forming at least one first chamber, which contains a unit dose of a liquid and/or solid detergent or cleaning agent, wherein
the second substantially water-soluble layer is preferably a substantially water-soluble film.

In various embodiments of the method for producing a detergent or cleaning agent product
a) providing the at least one first chamber comprises forming the at least one first chamber between the at least one first and the at least one second layer by the at least one first and the at least one second layer, or
b) providing the at least one first chamber comprises forming the at least one first chamber by a first structure, wherein the first structure comprises the at least one first layer, or
c) providing the at least one first chamber comprises forming the at least one first chamber by a first structure, wherein the first structure comprises the at least one second layer.

In some embodiments of the method for producing a detergent or cleaning agent product

in case b) the at least one second layer is provided such that the at least one second layer is formed such that it completely surrounds the first structure or
in case c) the at least one first layer is provided such that the at least one first layer is formed such that it completely surrounds the first structure.

In further embodiments of the method for producing a detergent or cleaning agent product

in case b) the at least one second layer is provided such that the at least one second layer and the third layer are formed such that they are in direct contact with each other or
in case c) the at least one first layer is provided such that the at least one first layer and the first structure are formed such that they are in direct contact with each other.

In various embodiments of the method for producing a detergent or cleaning agent product

in cases b) and c) the first structure comprises a third layer, which is a substantially water-soluble film, wherein in case b) the at least one first chamber is formed by the at least one second layer and the third layer, and wherein in case c) the at least one first chamber is formed by the at least one first layer and the third layer or
in case b) the first structure consists of the at least one first layer or
in case c) the first structure consists of the at least one second layer.

In various embodiments of the method for producing a detergent or cleaning agent product the at least one second layer is transparent and is formed such that the content of the at least one first chamber is visible from the outside through the at least one second layer.

In some embodiments of the method for producing a detergent or cleaning agent product the method comprises the establishment of contact between the at least one first and the at least one second layer, wherein the contact between the two layers is established by at least one method selected from the group consisting of printing methods, adhesive methods, welding methods, and moistening pressing and drying of the two layers.

In various embodiments of the method for producing a detergent or cleaning agent product the detergent or cleaning agent product is a detergent or cleaning agent product according to the first aspect of the present invention.

In a third aspect the present invention relates to a detergent or cleaning agent product which is obtainable by a method according to the second aspect of the present invention.

In a fourth aspect the present invention relates to a container which contains at least one detergent or cleaning agent product according to the first aspect or third aspect of the present invention.

In a fifth aspect the present invention relates to the use of a detergent or cleaning agent product according to the first or third aspect of the present invention as a detergent or dishwashing detergent.

### DESCRIPTION OF THE FIGURES

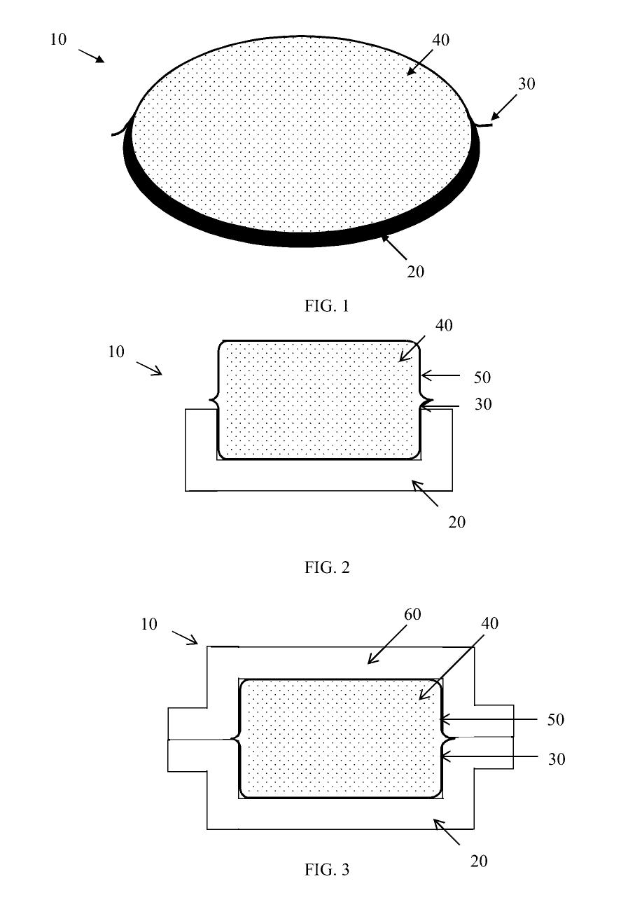

FIG. 1 shows a cross section through an embodiment of the detergent or cleaning agent product (10) of the present invention. The at least one first layer, which is a flexible, substantially water-soluble, substantially dry foam layer (20), forms a chamber with the at least one second substantially water-soluble layer (30), which chamber contains a unit dose of a liquid and/or solid detergent or cleaning agent (40).

FIG. 2 shows a cross section through an embodiment of the detergent or cleaning agent product (10) of the present invention. The product comprises a first layer, which is a flexible, substantially water-soluble, substantially dry foam layer (20). A first structure forms a chamber containing a unit dose of a liquid and/or solid detergent or cleaning agent (40). The first structure consists of the at least one second substantially water-soluble layer (30) and a third substantially water-soluble layer (50).

FIG. 3 shows a cross section through an embodiment of the detergent or cleaning agent product (10) of the present invention. The product comprises a first layer, which is a flexible, substantially water-soluble, substantially dry foam layer (20). A first structure forms a chamber containing a unit dose of a liquid and/or solid detergent or cleaning agent (40). The first structure consists of the at least one second substantially water-soluble layer (30) and a third substantially water-soluble layer (50). The product further comprises a fourth layer, which is a flexible, substantially water-soluble, substantially dry foam layer (60). The two flexible, substantially water-soluble, substantially dry foam layers (20) and (60) surround the first structure.

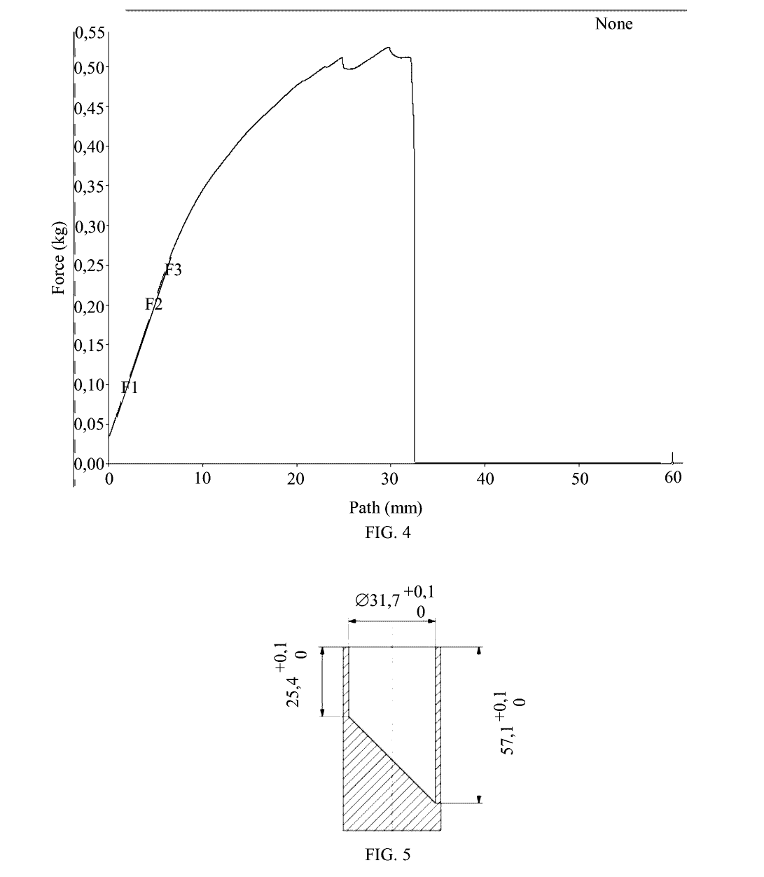

FIG. 4 shows a plot of force over path for determining the modulus of elasticity of a substantially dry, substantially water-soluble foam.

FIG. 5 shows the standard throat test which is used in accordance with European Standard 71-1.

### DETAILED DESCRIPTION OF THE INVENTION

The inventors of the present invention have surprisingly found that a detergent or cleaning agent product comprising: a) at least one first layer, which is a flexible, substantially water-soluble, substantially dry foam layer, b) at least one first chamber, and c) at least one second substantially water-soluble layer, wherein the at least one first chamber contains a unit dose of a liquid and/or solid detergent or cleaning agent, solves the problems described above.

Unit doses of detergents and cleaning agents can thus be combined with dry foams to form detergent and cleaning agent products. This has the advantage that the foam does not have to be created first by the consumer and a pressure-resistant packaging, as well as propellants are obsolete. Nevertheless, the product provides the consumer with the special properties associated with a foam. In addition, the combination with liquid and/or solid detergents ensures a significantly higher amount of active substance in the product, so that the products can be made significantly smaller than a product consisting solely of foam. This saves transport and packaging costs, since the products now have a smaller volume and thus less packaging material is required per item and more products per volume can be stored and transported. Nevertheless, the product is cushioned and padded by the foam layer and is therefore more resistant to transport-induced stresses.

The inventors of the present invention have surprisingly also found that new ingredient combinations are possible by combining the foams with liquid and/or solid detergents and cleaning agents. Liquid detergents can now be combined with bleaching agents in the foam, and therefore the problem posed by the use of bleaching agents in liquid detergent and cleaning agents, which has long been described in the prior art, is overcome by the present invention. The second substantially water-soluble coating allows the foam to combine intelligently with unit doses of liquid and/or solid detergents and cleaning agents. Furthermore, the detergent and cleaning agent products have a new and pleasant feel for the consumer as a result of the use of dry foam.

A detergent or cleaning agent product in the context of the present invention is an item comprising a unit dose of a detergent or cleaning agent. The product is ready to use and can be used for washing or cleaning.

Here, the product has the usual domestic dimensions. In particular embodiments, the product has a volume of 100 ml or less, preferably 75 ml or less, more preferably 50 ml or less, more preferably 40 ml or less, particularly preferably 30 ml or less, more preferably 25 ml or less, even more preferably 20 ml or less, more preferably still 15 ml or less.

The detergent and cleaning agent products demonstrate, in particular embodiments, a good dissolution and/or dispersion rate at temperatures between 10 and 60° C. and in particular between 20 and 45° C. In particular, the foam of the product of the present invention demonstrates a higher dispersion and/or dissolution rate than conventional films, in particular PVA, of the prior art. Particularly if the detergent or cleaning agent product comprises only a small proportion of water-soluble film and consists mainly of the unit dose of the detergent or cleaning agent and at least one foam layer, the overall solubility and/or dispersibility is significantly higher than that of comparable products having a higher film proportion, since the foam layers have a significantly higher solubility and/or dispersibility than water-soluble films. Especially when solid unit doses are used, films can be almost completely dispensed with, and hence the solubility and/or dispersibility of the detergent or cleaning agent product can be increased.

The at least one first layer is a flexible, substantially water-soluble, substantially dry foam layer.

The term “layer”, as used in the present invention refers to a flat body comprising the detergent or cleaning product. Here, a layer has certain chemical and physical properties. A layer originates from a separate manufacturing process that generates this layer as a definable body. A layer may also be created only during the production of the detergent or cleaning agent. Even if the layer is connected to a further, chemically and physically identical layer in a later step, it is still considered to be an independent layer within the meaning of the present invention.

The term “structure”, as used herein, refers to a uniform entity formed from one or more layers in the detergent or cleaning agent product. In particular embodiments, the term shall be construed such that the structure consists of at least one or more layers. In further embodiments a structure consists of one or more chemically and physically identical layers. In other embodiments a structure consists of chemically and/or physically dissimilar layers. Thus, a structure can have a flexible, substantially dry, substantially water-soluble foam layer and a substantially water-soluble film. The term also includes one or more foam layers or films which differ by one, two or three chemical constituents. Thus, the layers of a structure such can differ for example in terms of the contained surfactants, bleaching agents, or water-soluble polymer. Also, the layers of a structure may differ in terms of their physical characteristics. For example, they may thus differ in terms of their flexibility, modulus of elasticity, solubility or mean cell diameter.

A detergent or cleaning agent product may have one or more bodies. A body in the sense of the present invention may have any configuration other than that of a layer. In this sense, a body may be cuboid or spherical, for example.

“At least one” or “at least a” as used herein means 1 or more, for example, 1, 2, 3, 4, 5, or more.

“Liquid” in this context means that the corresponding preparations are flowable liquids, pastes or gels. “Solid” means that the corresponding preparations are in solid form, in powder form or are present as granules.

“Flexible” in the context of the present invention means that the claimed layer resumes its original shape again after a deformation. This is especially true when the layer has a modulus of elasticity determined at 25° C. by tensile tests in the linear range from 0.001 to 100 MPa, preferably from 0.01 to 10 MPa, in particular from 0.1 to 1 MPa. In particular, the foam of the at least one first layer has a modulus of elasticity determined at 25° C. by tensile tests in the linear range from 0.001 to 100 MPa, preferably from 0.01 to 10 MPa, in particular from 0.1 to 1 MPa. The measurements are taken with the “TA.XTplus Texture Analyser” apparatus from Stable Micro Systems. Details can be found in the examples.

The flexible, substantially dry, substantially water-soluble foam of the at least one first layer in particular embodiments has an average cell diameter of 10 to about 1,200 μm, preferably 200 to about 1,000 μm.

The term “foam” is understood in the present document to mean an entity formed of gas-filled, spherical or polyhedral cells, which are delimited by liquid, semi-liquid, highly viscous or solid cell walls. A substantially dry foam has highly viscous or solid cell walls.

The “average cell diameter” in the sense of the present invention is determined as follows. The cross section of a foamed portion foam piece was photographed digitally using a microscope. With reference to the digital photographs, the average diameter of 10 to 20 cells was taken as the average cell diameter by means of photo editing software. Here, if in doubt, in the case of irregularly shaped cells, the longest possible diameter of a cell was always determined and used for the calculation. For example, the ImageJ program is suitable software. ImageJ is a freely available program that allows Java-based image processing and has been developed at the National Institute of Health. The program is also suitable for determining the thickness of the cell walls. To calculate the sizes of objects in the photos, the pixel size of the digital camera and the magnification of the microscope must be consulted.

The flexible, substantially dry, substantially water-soluble foam of the at least one first layer has, in particular embodiments, a density from about 0.03 g/cm³ to about 0.30 g/cm³, in particular from about 0.04 g/cm³ to about 0.08 g/cm³, more particularly from about 0.05 g/cm³ to about 0.06 g/cm³. The density is determined by cutting a block measuring 10 mm×100 mm×100 mm from a piece of foam and weighing it.

The term “dry” in the sense of the present invention means that the foam has a water content of 6 wt. % or less.

A “substantially” dry foam has a water content of 10 wt. % or less. In particular embodiments the flexible, substantially dry, in substantially water-soluble foam layer of the at least one first layer has a water content of 10-2 wt. % to. In various embodiments the flexible, substantially dry, substantially water-soluble foam layer has a water content of 8-5 wt. %, in particular 7-6 wt. %. In various embodiments the flexible, substantially dry, substantially water-soluble foam layer has a water content of 10-1 wt. %, of 9-1 wt. %, of 8-1 wt. %, of 7-1 wt. %, of 6-1 wt. % or of 5-1 wt. %. These values apply to an air-conditioned, German laboratory, since the water content of the foam is in equilibrium with the ambient humidity.

“Water-soluble” in the sense of the present invention means that a component has a solubility in distilled water, measured at 25° C., from about at least 0.1 g/l. In some embodiments the components have a solubility of at least about 0.1 to about 500 g/l, measured at 25° C.

“Water-soluble layer” in the sense of the present invention means that the constituents of the layer have a solubility in distilled water, measured at 25° C., of about at least 0.1 g/l. In some embodiments the constituents of the layer have a solubility from about at least 0.1 to about 500 g/l, measured at 25° C. Usually the tested water-soluble substances require less than 30 minutes to dissolve.

A “substantially water-soluble layer” in the sense of the present invention means that at least 80 wt. % of the layer is water-soluble in the sense of the present invention. In particular embodiments at least 90 wt. %, at least 95 wt. %, at least 97.5 wt. %, at least 99 wt. % or at least 99.5 wt. % of the layer is water-soluble layer in the sense of the present invention.

The term “substantially water-soluble foam” means that at least 80 wt. % of the foam is water-soluble in the sense of the present invention. In particular embodiments at least 90 wt. %, at least 95 wt. %, at least 97.5 wt. %, at least 99 wt. % or at least 99.5 wt. % of the foam is water-soluble in the sense of the present invention.

Components which are not water-soluble and which are contained in the detergent or re dispersible at least in distilled water at 25° C. Therefore, the entire product is water-dispersible. The term water-dispersible means in particular that the material, when added to water or another aqueous solution at 25° C., forms a finely divided suspension.

A “chamber” in the sense of the present invention is a space which is closed on all sides. This chamber contains a unit dose of a liquid and/or solid detergent or cleaning agent. The wall of the chamber may be formed from one or more layers. The unit dose is encapsulated tightly by the chamber.

The term “first structure” is understood in particular embodiments to mean a part of the detergent or cleaning agent product which forms the at least one first chamber. The first structure is substantially water-soluble. The first structure may consist of one or more substantially water-soluble layers. The at least one first structure comprises the at least one first or the at least one second layer. The at least one first structure may comprise accordingly the flexible, substantially dry, substantially water-soluble foam of the first layer or the substantially water-soluble film of the second layer.

The term “unit dose” in the sense of the present invention refers to a physically isolated dose containing a predetermined amount of detergent or cleaning agent, which is necessary to achieve a desired detergent or cleaning effect.

In the context of “unit doses of detergents and cleaning agents” the term “detergents and cleaning agents” is to be understood to mean “detergent and cleaning agent preparation”.

According to a further preferred embodiment of the invention, the detergent or cleaning agent preparations can also be present in the form of solid substances compressed into bodies that can be of any shape; such molded bodies (such as tablets, blocks, briquettes, rings, etc.) are known from the prior art and can also be used within the scope of the present invention. In particular, such molded bodies can also have depressions, hollows, cutouts, etc., which serve for specific purposes of accommodating individual detergent preparations. Of course, molded bodies are used in combination with powders, in combination with liquids (the latter for example in a closed enclosure formed from a water-soluble material), or in combination with a detergent preparation within the scope of the present invention embedded in a fusible matrix.

Detergent or cleaning agent preparations present in liquid form, i.e. in the form of solutions, gels, suspensions or dispersions, are just as suitable and are included by the present invention and can be provided alone, combined with other liquid detergent preparations, or combined with solid detergent preparations in a single enclosure or in a combination of several, possibly interconnected, enclosures.

In various embodiments of the detergent or cleaning agent product the at least one second layer is a substantially water-soluble film.

The term “film” refers to a thin, flat, flexible sheet material that can be wound up, consisting of organic materials which may have been generated substantially in any manner, for example by extrusion, rolling, beating, casting, calendering or spraying. This layer is flexible in particular embodiments.

In particular, a film is flexible when it meets the following parameters:
a tear strength (ASTM D882, ISO 527) in the range from 20 N/mm² to 50 N/mm², preferably in the range from 25 N/mm² to 45 N/mm², further preferably in the range from 30 N/mm² to 40 N/mm2, even more preferably in the range from 32 N/mm² to 38 N/mm², and most preferably in the range from 34 N/mm² to 36 N/mm²; and/or
a modulus of elasticity (ASTM D882, ISO 527) in the range from 4 N/mm² to 20 N/mm², preferably in the range from 5 N/mm² to 18 N/mm², more preferably in the range from 6 N/mm² to 16 N/mm², even more preferably in the range from 8 N/mm² to 14 N/mm², and most preferably in the range from 10 N/mm² to 12 N/mm²; and/or
an elongation at break (ASTM D882, ISO 527) in the range from 150% to 1,000%, preferably in the range from 180% to 900%, more preferably in the range from 200% to 800%, even more preferably in the range from 250% to 750%, and most preferably in the range from 300% to 450%; and or
a tear propagation resistance (ASTM D1922, ISO 6383) of 20 g/mm² to 60 g/mm², preferably in the range from 25 g/mm² to 55 g/mm², more preferably in range from 30 g/mm² to 50 g/mm², even more preferably in the range from 32 g/mm² to 48 g/mm², and most preferably in the range from 35 g/mm² to 45 g/mm²; and or
an impact strength (ASTM D1709, DIN 53433) of 100 g to 2000 g, preferably in the range from 150 g to 1500 g, more preferably in the range from 200 g to 1000 g, even more preferably in the range from 300 g to 800 g, and most preferably in the range from 400 g to 750 g. The measurements are taken at 23° C. and 50% relative humidity.

In some embodiments of the detergent or cleaning agent product the at least one chamber is arranged between the at least one first and the at least one second layer and is formed by the at least one first and the at least one second layer.

In some embodiments of the detergent or cleaning agent product the at least one first chamber is formed by a first structure comprising the at least one first layer. In a more specific variant of this embodiment the at least one second layer surrounds the first structure completely. In particular embodiments the at least one second layer surrounds the first structure completely, wherein the second layer is not the outermost layer of the detergent or cleaning agent product. Furthermore, the at least one second layer and the first structure may be in direct contact with each other. In some embodiments the first structure comprises a third layer, which is a substantially water-soluble film which forms the at least one first chamber with at least one first layer. In various embodiments the first structure consists of the at least one first layer.

In some embodiments of the detergent or cleaning agent product the at least one first chamber is formed by a first structure comprising the at least one second layer. In a more specific variant of this embodiment the at least one first layer surrounds the first structure completely. The at least one first layer and the first structure may be in direct contact with each other. In some embodiments the first structure comprises a third layer, which is a substantially water-soluble film which forms the at least one first chamber with the at least one second layer. In various embodiments the first structure consists of the at least one second layer.

In various embodiments of the detergent or cleaning agent product the at least one second layer is transparent and is formed such that the content of the at least one first chamber is visible from the outside through the at least one second layer.

A transparent layer in the sense of the present invention is a layer which is transparent to light. In particular embodiments the layer is in particular permeable to light of the wavelength range from 380 nm to 780 nm.

The term “transparent”, as used herein, in various embodiments includes both transparent and translucent and means that a layer according to the invention has a transmittance of more than 25%, more preferably more than 30%, most preferably more than 40%, optimally more than 50% in the range 380-780 nm (approximately visible part of the spectrum). Alternatively, the extinction can be less than 0.6 (approximately equivalent to 25% transmission) or the permeability may be greater than 25%, wherein transmittance % are determined from the formula: iₑₓ/iᵢₙ×100%. For purposes of the invention it is true in various embodiments that, as long as a layer has more than 25% transmittance for a wavelength in the visible light range, it is considered to be transparent/translucent.

If the at least one second layer is transparent, unit dose of a detergent or cleaning agent present in the chamber, in particular a liquid unit dose of a detergent or cleaning agent, in particular embodiments contains a stabilizing agent, which stabilizes the contents in respect or decomposition and deactivation phenomena caused by light irradiation. Antioxidants, UV absorbers and fluorescent dyes have proven to be particularly suitable here.

In some embodiments of the detergent or cleaning agent product the flexible, substantially dry, substantially water-soluble foam layer of the at least one first layer comprises foamed, substantially water-soluble polymers and/or copolymers.

Within the scope of the present invention suitable water-soluble polymers are selected from the group consisting of (optionally partially acetylated) polymers of acrylic acid monomers and ethylenically unsaturated carboxylic acid monomers, polyacrylates, polymethacrylates, copolymers of acrylic acid and methacrylate, polyvinyl alcohol, polyvinylcaprolactam, polyvinylpyrrolidone, polyethylene oxide, gelatin, cellulose, pullulan, and derivatives thereof, starch and derivatives thereof, in particular modified starches, such as cellulose ethers, especially methyl celluloses, carboxymethycelluloses (CMCs) and hydroxypropyl methylcelluloses (HPMCs), and mixtures (polymer blends, composites, coextrudates, etc.) of said materials.

In some embodiments of the detergent or cleaning agent product the flexible, substantially dry, substantially water-soluble foam layer of the at least one first layer comprises foamed, substantially water-soluble polymer selected from the group consisting of (optionally partially acetylated) polymers of acrylic acid monomers and ethylenically unsaturated carboxylic acid monomers, polyacrylates, polymethacrylates, copolymers of acrylic acid and methacrylate, polyvinyl alcohol, polyvinylcaprolactam, polyvinylpyrrolidone, polyethylene oxide, gelatin, cellulose, pullulan, and derivatives thereof, starch and derivatives thereof, in particular modified starches, such as cellulose ethers, especially methyl celluloses, carboxymethycelluloses (CMCs) and hydroxypropyl methylcelluloses (HPMCs), and mixtures (polymer blends, composites, coextrudates etc.) of said materials.

In some embodiments of the detergent or cleaning agent product the flexible, substantially dry, substantially water-soluble foam layer of at least one first layer comprises foamed, substantially water-soluble polyvinyl alcohol and/or foamed, substantially water-soluble polyvinylpyrrolidone and/or foamed, substantially water-soluble copolymers thereof.

In various embodiments of the detergent or cleaning agent product the flexible, substantially dry, substantially water-soluble foam layer of the at least one first layer comprises at least one constituent which is selected from the group consisting of a surfactant, softener, perfume, perfume delivery system, dye, preservative, bittern, filler, excipient, special polymer and a functional additive.

In particular embodiments the detergent or cleaning agent product comprises the concept of special polymers, greying inhibitors, soil-repellent polymers and soil-suspending polymers.

In some embodiments the detergent or cleaning agent product has the flexible, substantially water-soluble, substantially dry layer of the at least one first layer and a second or more flexible, substantially dry, substantially water-soluble foam layers, which differ in terms of their composition in at least one constituent or differ in terms of at least one of their physical properties. Thus, the foams may differ, for example in terms of their average cell diameter, their modulus of elasticity and/or their density. Furthermore, the foams may differ in terms of their chemical composition, for example in terms of their contained dyes, bleaching agents, surfactants and/or water-soluble polymers.

It is also possible that the detergent or cleaning agent product, in addition to the flexible, substantially dry, substantially water-soluble foam layer of the first layer, comprises one or more other flexible, substantially dry, substantially water-soluble foam layers. This is illustrated for example in FIG. 3 In particular embodiments the detergent or cleaning agent product comprises two flexible, substantially dry, substantially water-soluble foam layers. These may surround the at least one second substantially water-soluble layer. Furthermore, the two foam layers may surround the at least one first structure having the second substantially water-soluble layer and forming the at least one first chamber.

As can be inferred from the present description, the detergent or cleaning agent products according to the invention are particularly suitable for the controlled release of the contained active substances from the group of the detergents or cleaning agents. In accordance with the invention, an embodiment in which the product as a whole is water-soluble or at least water-dispersible, i.e. (fully) dissolves under normal conditions of use during washing or machine washing if the conditions intended for the dissolution are achieved, is therefore preferred. A key advantage of this embodiment is that the product at least partially dissolves or disperses within a practically relevant short time—as a non-limiting example, this may be a few seconds to 5 minutes—under precisely defined conditions in the cleaning liquor, and thus introduces the encased content, i.e. the active cleaning material or plurality of materials into the liquor in accordance with requirements.

For example, in the case that the detergent or cleaning agent product comprises a third layer, the third layer may likewise be a flexible, substantially water-soluble, substantially dry foam layer. This can be formed similarly to the foam layer, defined herein, of the first layer. In some embodiments, if a third layer is present and this is a flexible, substantially water-soluble, substantially dry foam layer, this may be different from the flexible, substantially dry, substantially water-soluble foam layer of the first layer by the presence of another dye. The detergent or cleaning agent product then has at least two flexible, substantially water-soluble, substantially dry foam layers containing different dyes.

In particular embodiments of the detergent or cleaning agent product the detergent or cleaning agent product is substantially water-soluble.

In some embodiments of the detergent or cleaning agent product the detergent or cleaning agent product consists of
a) a first layer, which is a flexible, substantially water-soluble, substantially dry foam layer,
b) a first chamber and
c) a second substantially water-soluble layer,
   wherein the first chamber contains a unit dose of a liquid and/or solid detergent or cleaning agent.

The term surfactant is understood in particular embodiments of the present invention to mean a cleaning surfactant, that is to say a surfactant that actively removes stains from soiled textiles.

In various embodiments the flexible, substantially dry, substantially water-soluble foam layer of the at least one first layer comprises surfactant. In various embodiments the foam contains a single surfactant. In some embodiments the foam contains at least one surfactant. In different embodiments the surfactant is selected in particular from the group consisting of nonionic, cationic, anionic, and amphoteric surfactants and mixtures thereof. All surfactants which are disclosed in conjunction with the unit doses of liquid and solid detergents are also suitable. In various embodiments the proportion of surfactant in the foam is at least 0.1% by weight. The surfactant content is preferably 1 wt. % or more, 5 wt. % or more, 10 wt. % or more, 15 wt. % or more, 20 wt. % or more, or 25 wt. %, or more. In various embodiments the foam has up to 75 wt. %, up to 70 wt. %, up to 60 by weight, up to 50 wt. %, up to 40 wt. % or up to 30 wt. % surfactant. In particular, the foam has 1 to 75 wt. % or 10 to 50 wt. % surfactant.

The flexible, substantially dry, substantially water-soluble foam layer of the at least one first layer particularly preferably contains an anionic surfactant. Any anionic surfactants disclosed herein are suitable. Alk(en)yl sulfates are particularly suitable, preferably the alkali and especially the sodium salts of sulfuric acid half-esters of C₁₂-C₁₈ fatty alcohols, for example of coconut fatty alcohol, tallow fatty alcohol, lauryl, myristyl, cetyl or stearyl alcohol, or C₁₀-C₂₀ oxo alcohols and those half-esters of secondary alcohols of these chain lengths. The C₁₂-C₁₆ alkyl sulfates and C₁₂-C₁₅ alkyl sulfates and C₁₄-C₁₅ alkyl sulfates are preferred in terms of washing performance. Secondary and tertiary alkyl sulfates are also suitable anionic surfactants.

Fatty alcohol ether sulfates, such as the sulfuric acid monoesters of straight-chain or branched C₇₋₂₁ alcohols ethoxylated with 1 to 6 mol of ethylene oxide, such as 2-methyl-branched C₉₋₁₁ alcohols containing on average 3.5 mol of ethylene oxide (EO) or C₁₂₋₁₈ fatty alcohols with 1 to 4 EO, are also suitable. The anionic surfactant is preferably sodium lauryl ether (Texapon N70).

Further suitable nonionic surfactants are selected from the group consisting of polyethoxylated alkylphenols, polyethoxylated alcohols, polyethoxylated polyoxypropylene glycols, glycerol esters of alkanoic acids, polyglycerol esters of alkanoic acids, propylene glycol esters of alkanoic acids, sorbitan esters of alkanoic acids, polyethoxylated sorbitan esters of alkanoic acids, polyethoxylated glycol esters of alkanoic acids, polyethoxylated alkanoic acids, alkanolamides, N-alkylpyrrolidones, alkyl glycosides, alkyl polyglucosides, alkyl amine oxides, and polyethoxylated silicones.

Further suitable surfactants are selected from the group consisting of block copolymers of ethylene oxide and fatty alkyl groups, block copolymers of ethylene oxide and propylene oxide, hydrophobically modified polyacrylates, hydrophobically modified celluloses, silicone polyethers, silicone copolyol esters, diquaternary polydimethylsiloxanes and co-modified amino/polyether silicones.

In some embodiments the softener is selected from the group consisting of glycerol and polyols.

In particular embodiments the excipient is selected from the group consisting of thickeners and salts.

Suitable thickeners are, for example, those from the group of polymers of natural origin, such as agar-agar, carrageenan, tragacanth, gum arabic, alginates, pectins, polyoses, guar gum, carob bean flour, starch, dextrins, gelatin and casein. Thickeners that constitute modified natural materials, originate especially from the group of modified starches and celluloses, examples being carboxymethyl cellulose and other cellulose ethers, hydroxyethylcellulose and hydroxypropylcellulose, and also carob flour ether. Furthermore, microfibrillar bacterial celluloses are suitable as thickeners. A large group of thickeners that can be used widely in a wide range of different fields of application is constituted by the fully synthetic polymers, such as polyacrylic and polymethacrylic compounds, vinyl polymers, polycarboxylic acids, polyethers, polyimines, polyamides and polyurethanes. Xanthan is also suitable and preferred.

In some embodiments the special polymer is selected from the group consisting of acrylic acid (co)polymer, cationic hydroxymethylcellulose, carboxymethylcellulose and HPMC.

In further embodiments the functional additive is selected from the group consisting of silicone oils, bentonites, perfume capsules, perfume delivery systems, enzymes and bleach.

The bleach is preferably selected from the group of peroxy acids and amides of various peroxyacids, for example phthalimido peroxy hexanoic acid (PAP).

In further embodiments of the detergent or cleaning agent product the water-soluble polyvinyl alcohol and/or polyvinylpyrrolidone, and/or copolymers of the substantially dry, substantially water-soluble foam of the first flexible, substantially water-soluble layer has an average chain length from 600 to 12,000, in particular 1,000 to 8,000.

In particular embodiments of the detergent or cleaning agent product the water-soluble polyvinyl alcohol and/or polyvinylpyrrolidone, and/or copolymers of the second substantially water-soluble layer has an average chain length from 600 to 12,000, in particular 1,000 to 8,000. In particular embodiments the substantially comprises water-soluble film of the at least one second substantially water-soluble layer has an average chain length from 600 to 12,000, in particular 1,000 to 8,000.

In further embodiments both the water-soluble polyvinyl alcohol and/or polyvinylpyrrolidone, and/or copolymers of the flexible, substantially dry, substantially water-soluble foam layer of the at least one first layer and the water-soluble polyvinyl alcohol and/or polyvinylpyrrolidone, and/or copolymers of the at least one second substantially water-soluble layer, in particular the substantially water-soluble film of the substantially water-soluble at least one second layer, have an average chain length from 600 to 12,000, especially 1,000 to 8,000.

The term “average chain length” refers to the average number of monomer units in the backbone of a polymer chain within a population of polymer chains. The average chain length of a polymer is determined by gel permeation chromatography (GPC) using a UV-detector. Corresponding reference compositions/compounds are used for calibration.

In particular embodiments of the detergent or cleaning agent product the detergent or cleaning agent product comprises at least one second chamber comprising a unit dose of a solid and/or liquid detergent or cleaning agent.

In various embodiments of the detergent or cleaning agent product the at least one second chamber is formed similarly to the at least one first chamber.

This means that the at least one second chamber has the same configuration as the at least one first chamber. This means that the walls of the chambers are constructed by layers of the same type. The unit dose of the detergent or cleaning agent in the chamber can be identical or different. This means that in certain cases, the chambers have a unit dose in the same aggregate state. In other cases, the chambers have unit doses in different aggregate states. This means that in certain cases both chambers contain a liquid unit dose of detergent or cleaning agent. In other situations both chambers have a solid unit dose detergent or cleaning agent. In further instances one chamber has a fluid unit dose and the other chamber has a solid unit dose. Regardless of the state of aggregation unit doses, the chambers in certain cases have unit doses of different composition.

In particular embodiments of the detergent or cleaning agent product the at least one first chamber contains a unit dose of a liquid detergent or cleaning agent.

In some embodiments of the detergent or cleaning agent product the at least one second chamber contains a unit dose of a solid detergent or cleaning agent.

The at least one chamber of the detergent or cleaning agent product can be filled with the unit dose of the detergent or cleaning agent to at least 50 volume %, preferably at least 60%, preferably at least 70 volume %, more preferably at least 80 volume %, most preferably 90 volume % to ≦100 volume %.

In various embodiments of the detergent or cleaning agent product the flexible, substantially dry, substantially water-soluble foam layer of the at least one first layer has a modulus of elasticity determined at 25° C. by tensile tests in the linear range from 0.001 to 100 MPa, preferably from 0.01 to 10 MPa, in particular from 0.1 to 1 MPa.

In various embodiments of the detergent or cleaning agent product the at least one second layer is a substantially water-soluble film.

In particular embodiments of the detergent or cleaning agent product the at least one second substantially water-soluble layer is a substantially water-soluble polymer film.

In various embodiments the at least one second substantially water-soluble layer is a flexible layer.

In particular embodiments of the detergent or cleaning agent product the at least one second substantially water-soluble layer consists of a substantially water-soluble film, consisting substantially of substantially water-soluble polyvinyl alcohol and/or substantially water-soluble polyvinylpyrrolidone, and/or substantially water-soluble copolymers thereof.

Suitable water-soluble films are preferably based on a polyvinyl alcohol or a polyvinyl alcohol copolymer of which the molecular weight lies in the range from 10,000 to 1,000,000 gmol⁻¹, preferably 20,000 to 500,000 gmol⁻¹, more preferably 30,000 to 100,000 gmol⁻¹ and especially 40,000-80,000 gmol⁻¹ is. It is preferred for the film to contain polyvinyl alcohol or a polyvinyl alcohol copolymer.

Suitable water-soluble films are preferably based on a polyvinyl alcohol or a polyvinyl alcohol copolymer of which the molecular weight lies in the range from 10,000 to 1,000,000 gmol⁻¹, preferably 20,000 to 500,000 gmol⁻¹, more preferably 30,000 to 100,000 gmol⁻¹ and especially 40,000-80,000 gmol⁻¹.

Polyvinyl alcohol is usually prepared by hydrolysis of polyvinyl acetate, because the direct synthesis route is not possible. The same applies to polyvinyl alcohol copolymers, which are produced accordingly from polyvinyl acetate copolymers. It is preferred if at least one layer of the water-soluble wrapping comprises a polyvinyl alcohol of which the degree of hydrolysis is 70 to 100 mol %, preferably 80 to 90 mol %, particularly preferably 81 to 89 mol % and especially 82 to 88 mol %.

The acetate groups contained in the film material are partially hydrolyzed during the storage of the water-soluble packaging. In the case of a detergent or cleaning agent product according to the present invention, the inherent acetic acid odor is disguised by the perfume ingredients, which pass from the liquid detergent or cleaning agent through the wrapping, which is permeable for perfume ingredients, to the outer surface of the water-soluble packaging.

Preferred polyvinyl alcohol copolymers, in addition to vinyl alcohol, also comprise dicarboxylic acids as further monomers. Suitable dicarboxylic acids are itaconic acid, malonic acid, succinic acid, and mixtures thereof, wherein itaconic acid is preferred.

Polyvinyl alcohol copolymers that are also preferred comprise, in addition to vinyl alcohol, also an ethylenically unsaturated carboxylic acid, the salt or esters thereof. Such polyvinyl alcohol copolymers, in addition to vinyl alcohol, also particularly preferably contain acrylic acid, methacrylic acid, acrylic esters, methacrylic esters or mixtures thereof.

A film material suitable for the preparation of the water-soluble wrapping may additionally be combined with polymers selected from the group comprising acrylic acid-containing polymers, polyacrylamides, oxazoline polymers, polystyrene sulfonates, polyurethanes, polyesters, polyethers, polylactic acid, and/or mixtures of the above polymers.

Preferred polyvinyl alcohol copolymers comprise, in addition to vinyl alcohol, also dicarboxylic acids as further monomers. Suitable dicarboxylic acid are itaconic acid, malonic acid, succinic acid, and mixtures thereof, wherein itaconic acid is preferred.

Suitable water-soluble films for use in the present invention are films which are marketed under the name of Monosol M8630 from MonoSol LLC. Other suitable films include films with the name Solublon® PT, Solublon® KA, Solublon® KC or Solublon® KL from Aicello Chemical Europe GmbH or the films VF-HP from Kuraray.

The term “substantially water-soluble film” in the sense of the present invention means that at least 80 wt. % of the film is water-soluble in the sense of the present invention. In particular embodiments at least 90 wt. %, at least 95 wt. %, at least 97.5 wt. %, at least 99 wt. % or at least 99.5 wt. % of the film is water-soluble in the sense of the present invention.

The term that a “chamber is arranged between the at least one first and the at least one second layer and is formed by the at least one first and the at least one second layer” means that the chamber is located between the at least one first and the at least one second layer and the walls of the chamber are formed by the at least one first and the at least one second layer.

In particular embodiments the detergent or cleaning agent product has a first structure comprising a second layer and the third substantially water-soluble layer. In some embodiments the first structure consists of the second and the third layer. In various embodiments both layers are films. These are substantially water-soluble films, such as those described in the present application. In special cases the first structure consists of the second and the third layer, which are films. Then, the at least one first chamber is formed by the second and the third film layer. In particular cases the second and the third layer consist substantially of substantially water-soluble polyvinyl alcohol and/or substantially water-soluble polyvinylpyrrolidone, and/or substantially water-soluble copolymers thereof. For further details regarding the embodiment of the second and the third layer, reference is made to the further disclosure of this application.

In particular embodiments the detergent or cleaning agent product is a pouch.

The detergent or cleaning agent product may have a second, third, fourth or more flexible, substantially water-soluble, substantially dry foam layers, which are defined similarly to the at least one first flexible, substantially water-soluble, substantially dry foam layer of the at least one first layer.

### Unit Doses of Solid and Liquid Detergent or Cleaning Agent

Unit doses of the liquid and/or solid detergent or cleaning agent contained in the detergent or cleaning agent products according to the invention may contain all usual constituents of such agents which do not interact undesirably with the detergent or cleaning agent product.

The amount of detergent or cleaning agent in the unit dose is preferably 5 to 50 g in accordance with the invention, particularly preferably 10 to 30 g, especially 15 to 25 g.

### Unit Dose of a Liquid Detergent or Cleaning Agent

The liquid detergent or cleaning agent of the unit dose contains a surfactant, which for example may an anionic surfactant, a nonionic surfactant, a zwitterionic surfactant, a cationic surfactant or a mixture thereof. The liquid detergent or cleaning agent preferably contains anionic and nonionic surfactant.

Sulfonates and/or sulfates may be used preferably as anionic surfactant. The content of anionic surfactant is 5 to 25 wt. %, and preferably 8 to 20 wt. %, in each case in relation to the total detergent or cleaning agent.

C₉₋₁₃ alkylbenzene sulfonate, olefin sulfonates, i.e. mixtures of alkene and hydroxy alkane sulfonates and also disulfonates, as are obtained, for example, from C₁₂₋₁₈ monoolefins with end or internal double bond by sulfonation with gaseous sulfur trioxide and subsequent alkaline or acidic hydrolysis of the sulfonation products, are preferred surfactants of the sulfonate type. C₁₂₋₁₈ alkane sulfonates and the esters of α-sulfofatty acids (ester sulfonates), for example the α-sulfonated methyl esters of hydrogenated coconut, palm kernel or tallow fatty acids, are also suitable.

The alkali and in particular the sodium salts of the sulfuric acid half-esters of C₁₂-C₁₈ fatty alcohols, for example of coconut fatty alcohol, tallow fatty alcohol, lauryl, myristyl, cetyl or stearyl alcohol, or C₁₀-C₂₀ oxo alcohols and those half-esters of secondary alcohols of these chain lengths are preferred alk(en)yl sulfates. The C₁₂-C₁₆ alkyl sulfates and C₁₂-C₁₅ sulfates and C₁₄-C₁₅ alkyl sulfates are preferred in terms of the washing performance. Secondary and tertiary alkyl sulfates are also suitable anionic surfactants.

Fatty alcohol ether sulfates, such as the sulfuric acid monoesters of straight-chain or branched C₇₋₂₁ alcohols ethoxylated with 1 to 6 mol of ethylene oxide, such as 2-methyl-branched C₉₋₁₁ alcohols containing on average 3.5 mol of ethylene oxide (EO) or C₁₂₋₁₈ fatty alcohols with 1 to 4 EO, are also suitable.

Other suitable anionic surfactants are soaps. Saturated and unsaturated fatty acid soaps are suitable, such as the salts of lauric acid, myristic acid, palmitic acid, stearic acid, (hydrogenated) erucic acid and behenic acid and also in particular soap mixtures derived from natural fatty acids, for example coconut, palm kernel, olive oil or tallow fatty acids.

The anionic surfactants and soaps may be in the form of their sodium, potassium or magnesium or ammonium salts. The anionic surfactants are preferably in the form of their ammonium salts. Preferred counter ions for the anionic surfactants are the protonated forms of choline, triethylamine, monoethanolamine, or methylethylamine.

Suitable nonionic surfactants include alkoxylated fatty alcohols, alkoxylated fatty acid alkyl esters, fatty acid amides, alkoxylated fatty acid amides, polyhydroxy fatty acid amides, alkylphenol polyglycol ethers, amine oxides, alkyl polyglucosides, hydroxy mixed ethers and mixtures thereof.

Alkoxylated alcohols, advantageously ethoxylated alcohols, in particular primary alcohols having preferably 8 to 18 C atoms and an average of 4 to 12 mol of ethylene oxide (EO) per mol of alcohol, in which the alcohol group can be methyl-branched linearly or preferably in the 2-position or can contain linear and methyl-branched groups in mixture, as are usually present in oxo alcohol groups, are preferably used as nonionic surfactant. However, alcohol ethoxylates containing linear groups of alcohols of native origin with 12 to 18 C atoms, for example from coconut, palm, tallow fatty, or oleyl alcohol, and an average of 5 to 8 EO per mol of alcohol, are preferred in particular. The preferred ethoxylated alcohols include C₁₂₋₁₄ alcohols with 4 EO or 7 EO, C₉₋₁₁ alcohol with 7 EO, C₁₃₋₁₅ alcohols with 5 EO, 7 EO or 8 EO, C₁₂₋₁₈ alcohols with 5 EO or 7 EO and mixtures thereof. The specified degrees of ethoxylation represent statistical averages, which may be an integer or a fractional number for a specific product. Preferred alcohol ethoxylates have a narrowed homolog distribution (narrow range ethoxylates, NRE). In addition to these nonionic surfactants, fatty alcohols with more than 12 EO may also be used. Examples of these are tallow fatty alcohol with 14 EO, 25 EO, 30 EO or 40 EO. Nonionic surfactants containing EO and PO groups together in the molecule, are also used in accordance with the invention. A mixture of a (more heavily) branched ethoxylated fatty alcohol and an unbranched ethoxylated fatty alcohol, such as a mixture of a C₁₆₋₁₈ fatty alcohol with 7 EO and 2-propylheptanol with 7 EO, are also suitable. The detergent, cleaning agent, post-treatment agent or auxiliary detergent particularly preferably contains a C₁₂₋₁₈ fatty alcohol with 7 EO or C₁₃₋₁₅ oxo alcohol with 7 EO as nonionic surfactant.

The content of nonionic surfactant is from 1 to 25 wt. %, and preferably 2 to 20 wt. %, in each case in relation to the total liquid detergent or cleaning agent.

The total amount of anionic and nonionic surfactant in the liquid detergent or cleaning agent of the unit dose is up to 50 wt. %, preferably up to 45 wt. %, in relation to the total liquid detergent or cleaning agent.

In addition, the detergent or cleaning agent can contain further ingredients that further improve the performance and/or aesthetic properties of the detergent or cleaning agent. Within the scope of the present invention the detergent or cleaning agent in addition preferably contains or more substances from the group of builders, bleaching agents, bleach catalysts, bleach activators, enzymes, electrolytes, pH adjusters, perfumes, perfume carriers, fluorescence agents, dyes, hydrotropes, foam inhibitors, silicone oils, anti-redeposition agents, greying inhibitors, anti-shrink agents, anti-crease agents, color transfer inhibitors, antimicrobial active substances, germicides, fungicides, antioxidants, preservatives, corrosion inhibitors, antistatic agents, bitters, ironing aids, repellants and impregnating agents, skincare active substances, swelling and antislip agents, softening components, corrosion inhibitors and UV absorbers.

The unit doses of the liquid detergent or cleaning agent may contain water, wherein the content of water is preferably less than 20 wt. %, more preferably less than 15% by weight, even more preferably less than 10 wt. %, still more preferably less than 5 wt. %, in each case in relation to the total unit dose of detergent or cleaning agent. In special cases the content of water is preferably less than 5 wt. %, more preferably less than 4 wt. %, even more preferably less than 3 wt. %, still more preferably less than 2.5 wt. %, in each case in relation to the total unit dose of the detergent or cleaning agent.

In particular embodiments, the unit dose of a liquid detergent or cleaning agent comprises at least 10 wt. % glycerol, dipropylene glycol, surfactant, and a perfume.

### Unit Dose of a Solid Detergent or Cleaning Agent

Solid detergents and cleaning agents of the unit dose demonstrate a good dissolution rate at temperatures between 15 and 60° C. and in particular between 20 and 45° C. In particular, solid detergents which contain 20 to 45 wt. % surfactants are preferred.

The solid detergent or cleaning agents of the unit dose contain surfactants which are selected from the group consisting of anionic surfactants, nonionic surfactants, cationic surfactants and amphiphilic surfactants, and combinations thereof.

Anionic surfactants in this case are for example those of the sulfonate and sulfate type. Surfactants of the sulfonate type include alkylbenzenesulfonates (C₉C₁₅ alkyl), olefin sulfonates, i.e. mixtures of alkene and hydroxy alkane sulfonates and also disulfonates, as are obtained, for example, from C₁₂₋₁₈ monoolefins with end or internal double bond by sulfonation with gaseous sulfur trioxide and subsequent alkaline or acidic hydrolysis of the sulfonation products. Dialkane sulfonates, which are obtainable from C₁₂-C₁₈ alkanes by sulfochlorination or sulfoxidation and subsequent hydrolysis of neutralization by bisulfite addition of olefins, and in particular the esters of α-sulfofatty acids (ester sulfonates), for example the α-sulfonated methyl esters of hydrogenated coconut, palm kernel or tallow fatty acids, are also suitable.

Suitable surfactants of the sulfate type are constituted by the sulfuric acid monoesters of primary alcohols of natural and synthetic origin, i.e. of fatty alcohols, for example coconut fatty alcohols, tallow fatty alcohols, oleyl alcohol, lauryl, myristyl, palmityl or stearyl alcohol, or C₁₀-C₂₀ oxo alcohols, and those of secondary alcohols of this chain length. The sulfuric acid monoesters of alcohols ethoxylated with 1 to 6 mol of ethylene oxide, such as 2-methyl-branched C₉-C₁₁ alcohols containing on average 3.5 mol of ethylene oxide are suitable. Similarly, sulfated fatty acid monoglycerides are also suitable.

Furthermore, soaps made from natural or synthetic, preferably saturated fatty acids can also be used, for example. In particular, soap mixtures derived from natural fatty acids, for example coconut, palm kernel or tallow fatty acids, are suitable. Those which are composed in a proportion from 50 to 100% of saturated C₁₂-C₁₈ fatty acid soaps and in a proportion from 0 to 50% of oleic acid soaps are preferred.

The anionic surfactants may be in the form of their sodium, potassium and ammonium salts and as soluble salts of organic bases such as mono-, di- or triethanolamine. The amount of anionic surfactants or anionic surfactant mixtures in the unit dose is preferably from 5 to 40, in particular 8 to 35 wt. %. It is particularly advantageous if the sulfonate and/or sulfate content of the detergent or cleaning agent is 10 to 35 wt. %, in particular 15 to 30 wt. %, and if the soap content is up to 8 wt. %, in particular 0.5-5 wt. %.

The anionic surfactants can be used in solid, for example in spray-dried or granulated form, or in liquid to paste form. Thus, it is preferred to introduce the anionic surfactants used as softeners and/or lubricants into the process in the form of an aqueous surfactant paste.

The content of the ethoxylated alcohols are used as nonionic surfactants is preferably from 1 to 15 wt. % and in particular 2 to 10 wt. %. The detergents or cleaning agents preferably contain up to 5 wt. %, in particular 1 to 3 wt. %, of polyethylene glycol having a relative molecular mass between 200-1,500.

The weight ratio of anionic surfactant:nonionic surfactant is preferably at least 1:1 and especially 2:1 to 6:1.

In addition, alkyl glycosides of the general formula R—O-(G)ₓ, in which R is a primary straight-chain aliphatic group methyl-branched in the 2-position with 8 to 22, preferably 12 to 18 C atoms, G is a symbol that stands for a glycoside unit with 5 or 6 C atoms, and the degree of oligomerisation x is between 1 and 10, preferably between 1 and 2, and in particular is much smaller than 1.4, can also be used as nonionic surfactants, for example in amounts from 1 to 10 wt. %.

Suitable organic and inorganic builders are soluble and/or insoluble components which react in a weakly acidic, neutral or alkaline manner, precipitate out calcium ions, or are capable of forming complexes.

Other ingredients of the method products according to the invention can be inorganic and organic builder substances. The inorganic builder substances include water-insoluble or non-water-soluble ingredients such as aluminosilicates and in particular zeolites.

In a preferred embodiment the detergent or cleaning agent according to the invention does not contain any phosphate.

The detergent or cleaning agent according to the invention may advantageously have a zeolite content of at least 10 wt. %, for example at least 15 wt. % or at least 20 wt. % or at least 30 wt. % or even higher, for example at least 50 wt. %, in relation to the total detergent or cleaning agent. A possible minimum amount of zeolite may lie, for example, at a value of 1 wt. %, 5 wt. %, or also 10 wt. %, in relation to the total detergent or cleaning agent.

Soluble builders can be contained in the detergent or cleaning agent according to the invention preferably in amounts of 0.1 wt. % to 40 wt. %, preferably 5 wt. % to 25 wt. % and particularly preferred 10 wt. % to 20 wt. %, in relation to the total weight of the detergent or cleaning agent, wherein sodium carbonate is particularly preferred as the soluble builder. However, the detergent or cleaning agent according to the invention may also advantageously contains less than 10 wt. %, for example less than 5 wt. % of soluble builder. According to another preferred embodiment the detergent or cleaning agent according to the invention is free from soluble builder.

Usable finely crystalline, synthetic zeolite containing bound water is preferably zeolite A and/or P. For example, zeolite MAP® (commercial product from Crosfield) is particularly preferred as zeolite P. However, zeolite X and mixtures of A, X and/or P are also suitable. Of particular interest is also a co-crystallized sodium/potassium-aluminum silicate formed from zeolite A and zeolite X, which is commercially available as VEGOBOND AX® (commercial product from Condea Augusta S.p.A.).

The zeolite can be used as spray-dried powder or even as an stabilized suspension, which is still moist from preparation thereof. For the case that the zeolite is used as a suspension, this may contain small additions of nonionic surfactants as stabilizers, for example 1 to 3 wt. %, in relation to zeolite, of ethoxylated C₁₂-C₁₈ fatty alcohols with 2 to 5 ethylene oxide groups, C₁₂-C₁₄ fatty alcohols with 4 to 5 ethylene oxide groups, or ethoxylated isotridecanols. Suitable zeolites have an average particle size of preferably less than 10 μm (volume distribution, as measured by the Coulter Counter method) and contain preferably 18 to 22 wt. %, preferably 20 to 22 wt. %, of bound water.

Further particularly suitable zeolites are zeolites of the faujasite type. Together with the zeolites X and Y, the mineral faujasite belongs to the faujasite-types within the zeolite structural group 4, which are characterized by the double six-ring D6R subunit. Besides the specified faujasite types, the minerals chabazite and gmelinite and the synthetic zeolites R (chabazite type), S (gmelinite type), L and ZK-5 also belong to zeolite structural group 4. The latter two synthetic zeolites have no mineral analogs.

Zeolites of the faujasite type are composed of β-cages linked tetrahedrally via D6R subunits, wherein the β-cages are arranged similarly to the carbon atoms in diamond. The three-dimensional network of the zeolites of the faujasite type suitable in accordance with the invention has pores of 2.2 and 7.4 A, the unit cell also contains 8 wells with approximately 13 A diameter and can be described by the formula Na₈₆[(AIO₂)₈₆(SiO₂)₁₀₆] 264 H₂O. The network of the zeolite X contains a void volume of about 50%, in relation to the dehydrated crystal, which constitutes the largest empty space of all known zeolites (zeolite Y: approx. 48% void volume, faujasite: approx. 47% void volume). Within the scope of the present invention, the term “zeolite of the faujasite type” characterizes all three zeolites which form the Faujasite subgroup of zeolite structural group. 4 In addition to zeolite X, zeolite Y and faujasite and mixtures of these compounds are also suitable in accordance with the invention, wherein pure zeolite X is preferred.

Mixtures or co-crystals of zeolites of the faujasite type with other zeolites, which do not necessarily have to belong to zeolite structural group 4, are suitable in accordance with the invention, wherein preferably at least 50 wt. % of the zeolites are of the faujasite type.

The suitable aluminum silicates are commercially available, and the methods used for representation thereof are described in standard monographs.

Examples of commercially available zeolites of the X type can be described by the following formulas:

Na₈₆E(AIO₂)₈₆(SiO₂)₁₀₆] x H₂O, K₈₆[(AIO₂)₈₆(SiO₂)₁₀₆] x H₂O, Ca₄₀Na₆[(AIO₂)₈₆(SiO₂)₁₀₆] x H₂O, Sr₂₁Ba₂₂[(AIO₂)₈₆(SiO₂)₁₀₆] x H₂O, where x may be from greater than 0 to 276. These zeolites have pore sizes from 8.0 to 8.4 A.

Zeolite A-LSX, which corresponds to a co-crystal of zeolite X and zeolite A and in its anhydrous form has the formula (M_{2/n}O+M′_{2/n}O)□Al₂O₃□zSiO₂, wherein M and M′ can be alkali or alkaline earth metals and z is a number from 2.1 to 2.6, is also suitable, by way of example. This product is commercially available under the brand name VEGOBOND AX from CONDEA Augusta S.p.A.

Zeolites of the Y type are also commercially available and can be described, for example, by the formulas

Na₅₆[(AIO₂)₅₆(SiO₂)₁₃₆] x H₂O, K₅₆[(AIO₂)₅₆(SiO₂)₁₃₆] x H₂O, where x is a number from greater than 0 to 276. These zeolites have pore sizes of 8.0 A.

The particle sizes of the suitable zeolites advantageously lies in the range from 0.1 μm to 100 μm, preferably from 0.5 μm to 50 μm, and in particular from 1 μm to 30 μm, measured in each case using standard particle size determination methods. According to another preferred embodiment the detergent or cleaning agent according to the invention is free from zeolite.

In a preferred embodiment of the invention all contained inorganic constituents, i.e. all constituents to be incorporated during the process, are preferably water-soluble. In these embodiments, therefore, builder substances other than the listed zeolites are used.

Other suitable builders are polyacetals, which may be obtained by reacting dialdehydes with polyolcarboxylic acids having 5 to 7 C atoms and at least 3 hydroxyl groups. Preferred polyacetals are obtained from dialdehydes such as glyoxal, glutaraldehyde, terephthalaldehyde and mixtures thereof and from polyolcarboxylic acids, such as gluconic acid and/or glucoheptonic acid.

Further suitable organic builder substances are dextrins, for example oligomers or polymers of carbohydrates, which can be obtained by partial hydrolysis of starches. The hydrolysis can be carried out by customary, for example acid- or enzyme-catalyzed, processes. They are preferably hydrolysis products with average molar masses in the range from 400 to 500,000 g/mol. Here, a polysaccharide with a dextrose equivalent (DE) in the range from 0.5 to 40, in particular from 2 to 30, is preferred, wherein DE is a customary measure for the reducing effect of a polysaccharide compared with dextrose, which has a DE of 100. It is possible to use both maltodextrins with a DE between 3 and 20 and dry glucose syrups with a DE between 20 and 37, and also so-called yellow dextrins and white dextrins with higher molar masses in the range from 2,000 to 30,000 g/mol. A preferred dextrin is described in British patent application 94 19 091. The oxidized derivatives of such dextrins are their reaction products with oxidizing agents which are able to oxidize at least one alcohol function on the saccharide ring to the carboxylic acid function.

Oxydisuccinates and other derivatives of disuccinates, preferably ethylenediamine disuccinate, are further suitable cobuilders. Ethylenediamine N,N′-disuccinate (EDDS) is preferably used here in the form of its sodium or magnesium salts. In addition, preference is also given in this context to glycerol disuccinates and glycerol trisuccinates. Suitable quantities for use lie, for example, at 3 to 15 wt. %, in relation to the total detergent or cleaning agent.

Further organic cobuilders which can be used are, for example, acetylated hydroxycarboxylic acids and salts thereof, which can optionally also be in the lactone form and which comprise at least 4 carbon atoms and at least one hydroxyl group and at most two acid groups.

A further class of substance with cobuilder properties is represented by the phosphonates. These are, in particular, hydroxyalkane phosphonates and aminoalkane phosphonates. Among the hydroxyalkane phosphonates, 1-hydroxyethane-1,1-diphosphonate (HEDP) is of particular importance as cobuilder. It is preferably used as the sodium salt, the disodium salt giving a neutral reaction and the tetrasodium salt giving an alkaline (pH 9) reaction. Suitable aminoalkane phosphonates are preferably ethylenediamine tetra-methylene phosphonate (EDTMP), diethylenetriamine pentamethylene phosphonate (DTPMP) and higher homologs thereof. They are preferably used in the form of the neutrally reacting sodium salts, e.g. as the hexasodium salt of EDTMP or as the hepta- and octasodium salt of DTPMP. As a builder in this case, preference is given to using HEDP from the class of phosphonates. Furthermore, the aminoalkane phosphonates have a marked heavy-metal-binding capacity. Accordingly, and especially if the detergent and cleaning agents also contain bleach, it may be preferred to use aminoalkanephosphonates, in particular DTPMP, or to use mixtures of said phosphonates.

In cases where a phosphate content is tolerated, phosphates may also be used, especially pentasodium triphosphate, and possibly even pyrophosphates and orthophosphates, which act primarily as precipitants for lime salts. Phosphates are used predominantly in automatic dishwashing detergents, but also partly in detergents.

Alkali metal phosphates is the collective term here for the alkali metal (especially sodium and potassium) salts of the various phosphoric acids, wherein a distinction can be made between metaphosphoric (HPO₃)ₙ and orthophosphoric acid H₃PO₄ in addition to higher molecular weight representatives. The phosphates combine several advantages: they act as alkali carriers, prevent lime deposits on machine parts and lime encrustations in fabrics, and additionally contribute to cleaning performance.

Sodium dihydrogen phosphate, NaH₂PO₄, exists as the dihydrate (density 1.91 gcm⁻³, melting point 60°) and as the monohydrate (density 2.04 gcm⁻³). Both salts are white powders, very easily soluble in water, that lose their water of crystallization upon heating and transition at 200° C. into the weakly acidic diphosphate (disodium hydrogendiphosphate, Na₂H₂P₂O₇), and at higher temperature into sodium trimetaphosphate (Na₃P₃O₉) and Maddrell's salt (see below). NaH₂PO₄ reacts in acidic fashion; it is created when phosphoric acid is adjusted with sodium hydroxide to a pH of 4.5 and the mash is spray-dried. Potassium dihydrogen phosphate (primary or monobasic potassium phosphate, potassium diphosphate, KDP), KH₂PO₄, is a white salt of density 2.33 gcm⁻³, has a melting point of 253° [decomposing to form potassium polyphosphate (KPO₃)ₓ], and is easily soluble in water.

Disodium hydrogen phosphate (secondary sodium phosphate), Na₂HPO₄, is a colorless, very easily water-soluble crystalline salt. It exists anyhdrously and with 2 mol (density 2.066 gcm⁻³, water lost at 95°), 7 mol (density 1.68 gcm⁻³, melting point 48° with loss of 5 H₂O), and 12 mol of water (density 1.52 gcm⁻³, melting point 35° with loss of 5 H₂O); it becomes anhydrous at 100°, and when further heated transitions into the diphosphate Na₄P₂O₇. Disodium hydrogen phosphate is produced by neutralizing phosphoric acid with a soda solution using phenolphthalein as indicator. Dipotassium hydrogen phosphate (secondary or dibasic potassium phosphate), K₂HPO₄, is an amorphous white salt that is easily soluble in water.

Trisodium phosphate (tertiary sodium phosphate), Na₃PO₄, exists as colorless crystals that as the dodecahydrate have a density of 1.62 gcm⁻³ and a melting point of 73 to 76° C. (decomposition), as the decahydrate (corresponding to 19 to 20% P₂O₅) have a melting point of 100° C., and in anhydrous form (corresponding to 39 to 40% P₂O₅) have a density of 2.536 gcm⁻³. Trisodium phosphate is easily soluble in water with an alkaline reaction, and is produced by evaporating a solution of exactly 1 mol disodium phosphate and 1 mol NaOH. Tripotassium phosphate (tertiary or tribasic potassium phosphate), K₃PO₄, is a white, deliquescent, granular powder with a density of 2.56 gcm⁻³, has a melting point of 1340° C., and is easily soluble in water with an alkaline reaction. It is produced, for example, upon heating of basic slag with carbon and potassium sulfate. Despite the higher price, the more easily soluble and therefore highly active potassium phosphates are greatly preferred over corresponding sodium compounds in the cleaning-agent industry.

Tetrasodium diphosphate (sodium pyrophosphate), Na₄P₂O₇, exists in anhydrous form (density 2.534 gcm⁻³, melting point 988°, also indicated as 880°) and as the decahydrate (density 1.815 to 1.836 gcm⁻³, melting point 94° with loss of water). Both substances are colorless crystals that are soluble in water with an alkaline reaction. Na₄P₂O₇ is created when disodium phosphate is heated to >200°, or by reacting phosphoric acid with soda at the stoichiometric ratio and dewatering the solution by spraying. The decahydrate complexes heavy-metal salts and hardness constituents, and therefore decreases water hardness. Potassium diphosphate (potassium pyrophosphate), K₄P₂O₇, exists in the form of the trihydrate and represents a colorless, hygroscopic powder with a density of 2.33 gcm⁻³ that is soluble in water, the pH of a 1% solution being 10.4 at 25°.

Condensation of NaH₂PO₄ or KH₂PO₄ yields higher-molecular-weight sodium and potassium phosphates, within which a distinction can be made between cyclic representatives (the sodium or potassium metaphosphates) and chain types (the sodium or potassium polyphosphates). For the latter in particular, a number of designations are in use: fused or thermal phosphates, Graham's salt, Kurrol's salt, and Maddrell's salt. All the higher sodium and potassium phosphates are together referred to as condensed phosphates.

The industrially important pentasodium triphosphate Na₅P₃O₁₀ (sodium tripolyphosphate) is a white, water-soluble, non-hygroscopic salt, crystallizing anhydrously or with 6 H₂O, of the general formula NaO—[P(O)(ONa)—O]ₙ—Na, where n=3. Approximately 17 g of the salt containing no water of crystallization dissolves in 100 g of water at room temperature, approx. 20 g at 60° C., and approximately 32 g at 100°; after the solution is heated to 100° for two hours, approx. 8% orthophosphate and 15% disphosphate are produced by hydrolysis. In the production of pentasodium triphosphate, phosphoric acid is reacted with a soda solution or sodium hydroxide at the stoichiometric ratio, and the solution is dewatered by spraying. Like Graham's salt and sodium diphosphate, pentasodium triphosphate dissolves many insoluble metal compounds (including lime soaps). Pentapotassium triphosphate K₅P₃O₁₀ (potassium tripolyphosphate) is marketed, for example, in the form of a 50 wt. % solution (>23% P₂O₅, 25% K₂O). Potassium polyphosphates are widely used in the detergent and cleaning-agent industry. Sodium potassium tripolyphosphates also exist and are likewise usable within the scope of the present invention. They are produced, for example, when sodium trimetaphosphate is hydrolyzed with KOH:

(NaPO₃)₃+2KOH□Na₃K₂P₃O10+H₂O

These are usable in accordance with the present invention in just the same way as sodium tripolyphosphate, potassium tripolyphosphate, or mixtures of the two; mixtures of sodium tripolyphosphate and sodium potassium tripolyphosphate, or mixtures of potassium tripolyphosphate and sodium potassium tripolyphosphate, or mixtures of sodium tripolyphosphate and potassium tripolyphosphate and sodium potassium tripolyphosphate are also usable in accordance with the present invention.

In a preferred embodiment of the invention carbonates and silicates in particular are used as inorganic builder substances.

Examples cited here include in particular crystalline, layered sodium silicates of general formula NaMSiₓO₂ₓ₊1□yH₂O, where M is sodium or hydrogen, x is a number from 1.6 to 4, preferably 1.9 to 4.0, and y is a number from 0 to 20 and preferred values for x are 2, 3 or 4. Since such crystalline silicates in a spray drying process at least partially lose their crystalline structure, however, crystalline silicates are preferably admixed subsequently to the direct or after-treated spray-dried product. Preferred crystalline phyllosilicates of the given formula are those in which M stands for sodium and x assumes the value 2 or 3. In particular, both β- and δ-sodium disilicates Na₂S1₂O₅ yH₂O are preferred. Commercially, compounds of this type can be found for example under the name SKS® (Clariant). SKS-6® is primarily a δ-sodium disilicate with the formula Na₂Si₂O₅□yH₂O, SKS-7® is primarily the β-sodium disilicate. Reaction with acids (for example citric acid or carbonic acid), results in kanemite NaHSi₂O₅ yH₂O from δ-sodium disilicate, known commercially under the names SKS-9® or SKS-10® (Clariant). It may also be advantageous to use chemical modifications of these phyllosilicates. For example, the alkalinity of the phyllosilicates can be influenced. Phyllosilicates doped with phosphate or with carbonate have modified crystal morphologies compared with the δ-sodium disilicate, dissolve more rapidly and demonstrate an increased calcium binding ability compared to δ-sodium disilicate. Thus, phyllosilicates of the general empirical formula x Na₂O₅□ySiO₂□zP₂O₅ in which the ratio of x to y corresponds to a number from 0.35 to 0.6, the ratio of x to z corresponds to a number from 1.75 to 1,200, and the ratio of y to z corresponds to a number from 4 to 2,800, are known. The solubility of the phyllosilicates can also be increased by using particularly finely dispersed phyllosilicates. Also, compounds of the crystalline phyllosilicates can be used with other ingredients. Here, compounds with cellulose derivatives, which have an advantageous disintegrating effect, and compounds with polycarboxylates, for example citric acid, or polymeric polycarboxylates, for example copolymers of acrylic acid, can be cited in particular.

The preferred builder substances also include amorphous sodium silicates with an Na₂O:SiO₂ module from 1:2 to 1:3.3, preferably 1:2 to 1:2.8, and in particular 1:2 to 1:2.6, which have secondary washing properties. Within the scope of this invention, the term “amorphous” also means “X-ray amorphous”. This means that the silicates in X-ray diffraction experiments do not produce sharp X-ray reflexes typical of crystalline substances, but at best one or more maxima of the scattered X-rays, which have a width of several degrees of the diffraction angle. However, particularly good builder properties may well be obtained if the silicate particles in electron diffraction experiments fade or even provide sharp diffraction peaks. This may be interpreted such that the products have microcrystalline regions with a size from 10 to several hundred nm, wherein values up to max. 50 nm and especially up to 20 nm are preferable. Such X-ray amorphous silicates, which also dissolve with delay in relation to conventional water glasses, are known. Especially preferred are compressed/compacted amorphous silicates, compounded amorphous silicates and overdried X-ray amorphous silicates. The content of the (X-ray) amorphous silicates in particular in zeolite-free agents is preferably 1 to 10 wt. %, which corresponds to a preferred embodiment of the invention.

Particularly preferred inorganic water-soluble builders are alkali metal carbonates and alkali metal bicarbonates, wherein sodium carbonate and potassium carbonate and in particular sodium carbonate are among the preferred embodiments. The content of alkali metal carbonates in particular in zeolite-free agents may vary within a very broad range and is preferably 1 to 50 wt. %, advantageously 5 to 40 wt. %, in particular 8 to 30 wt. %, wherein the content of alkali metal carbonates is usually higher than (X-ray) amorphous silicates. According to another preferred embodiment the detergent or cleaning agent according to the invention is free from alkali metal carbonates. Useful organic structural substances are, for example, the polycarboxylic acids usable in the form of their alkali and especially sodium salts, such as citric acid, adipic acid, succinic acid, glutaric acid, tartaric acid, sugar acids, amino carboxylic acids, nitrilotriacetic acid (NTA), providing its use is not objectionable for environmental reasons, and mixtures thereof. Preferred salts are the salts of polycarboxylic acids such as citric acid, adipic acid, succinic acid, glutaric acid, tartaric acid, sugar acids and mixtures thereof. The acids per se may also be used. The acids, in addition to their builder effect, also typically have the property of an acidifying component and thus serve, for example in the method products according to the invention, also to establish a lower and milder pH of detergents or cleaning agents. Citric acid, succinic acid, glutaric acid, adipic acid, gluconic acid and mixtures thereof are mentioned here in particular.

Polymeric polycarboxylates are also suitable as organic builders, these being for example the alkali metal salts of polyacrylic or polymethacrylic acid, for example those with a relative molecular mass of 500 to 70,000 g/mol. The molar masses given for polymeric polycarboxylates are, for the purposes of this specification, weight-average molar masses M_{w} of the particular acid form, which were determined by gel permeation chromatography (GPC) using a UV detector. The measurement was taken here against an external polyacrylic acid standard, which, with the polymers under investigation, provides realistic molecular weight values on account of its structural similarity. These values differ distinctly from the molecular weights measured against polystyrene sulfonic acids as standard. The molar masses measured against polystyrene sulfonic acids are generally significantly higher than the molecular weights specified in this specification.

The detergent or cleaning agents according to the invention can also contain polymers. Suitable polymers include in particular polyacrylates, which preferably have a molecular mass from 2,000 to 20,000 g/mol. Owing to their superior solubility, the short-chain polyacrylates from this group having molar masses from 2,000 to 10,000 g/mol, and particularly preferably from 3,000 to 5,000 g/mol, may be preferred.

Copolymeric polycarboxylates, especially those of acrylic acid with methacrylic acid and of acrylic or methacrylic acid with maleic acid, are also suitable. Copolymers of acrylic acid with maleic acid containing 50 to 90 wt. % acrylic acid and 50 to 10 wt. % maleic acid have proven to be particularly suitable. Their relative molecular mass, based on free acids, is generally from 2,000 to 70,000 g/mol, preferably 20,000 to 50,000 g/mol and in particular 30,000 to 40,000 g/mol. The content organic builder substances in the detergent or cleaning agent can vary within a wide range. Preference is given to contents from 2 to 20 wt. %, wherein in particular contents of at most 10 wt. % are particularly appealing. According to another preferred embodiment, the detergent or cleaning agent according to the invention is free from organic builder substances.

The other detergent constituents include greying inhibitors (soil carriers), foam inhibitors, bleaching agents and bleach activators, optical brighteners, enzymes, fabric softening agents, dyes and fragrances and neutral salts.

Among the compounds used as bleaching agents, yielding H₂O₂ in water, sodium perborate tetrahydrate (NaBO₂□H₂O₂□3H₂O) and sodium perborate monohydrate (NaBO₂□H₂O₂) are particularly important. Other useful bleaching agents are, for example, peroxycarbonate (Na₂CO₃□1,5H₂O₂), peroxypyrophosphate, citrate perhydrate, and peracid salts or peracids yielding H₂O₂, such as perbenzoates, peroxaphthalates, diperazelaic acid or diperdodecanedioic acid. The content of bleaching agents in the detergent or cleaning agent is preferably 5 to 25 wt. %, more preferably 10 to 20 wt. %, wherein peroxycarbonate is used advantageously.

To obtain an improved bleaching effect where washing is carried out at temperatures of 60° C. and lower, bleach activators may be incorporated in the preparations. Examples of suitable bleach activators are N-acyl or O-acyl compounds which form organic peracids with H₂O₂, preferably N,N′-tetraacylated diamines, such as N,N,N′,N′-tetraacetyl ethylenediamine, and also carboxylic anhydrides and esters of polyols, such as glucose pentaacetate.

The content of bleach activator in the bleach-containing detergent or cleaning agent is in the usual range, preferably between 1 and 10 wt. %, and in particular between 3 and 8 wt. %.

Graying inhibitors have the task of keeping the dirt detached from the fiber suspended in the liquor and thus the task of preventing greying. Water-soluble colloids of mostly organic nature are suitable for this purpose, such as the water-soluble salts of polymeric carboxylic acids, glue, gelatin, salts of ether carboxylic acids or ether sulfonic acids of starch or cellulose or salts of acidic sulfuric acid esters of cellulose or starch. Water-soluble polyamides containing acidic groups are suitable for this purpose. Soluble starch preparations and starch products other than those mentioned above can also be used, for example degraded starch, aldehyde starches, etc. Polyvinylpyrrolidone is also usable. Carboxymethylcellulose (Na salt), methylcellulose, methylhydroxyethyl cellulose and mixtures thereof, and also polyvinylpyrrolidone are preferably used, in particular in amounts from 0.5 to 5 wt. %, in relation to the detergent or cleaning agent.

The foaming power of the surfactants can be increased or reduced by combining suitable surfactant types; a reduction can also be achieved by adding non-surfactant-like organic matter.

Reduced foaming, which is desirable when working with machines, can be achieved by combining various types of surfactants, for example sulfates and/or sulfonates with nonionic surfactants and/or soaps. In the case of soaps the foam-suppressing effect rises with the degree of saturation and the number of C atoms in the fatty acid ester. Soaps of natural and synthetic origin which have a high proportion of C₁₈-C₂₄ fatty acids are therefore suitable as foam-inhibiting soaps. Suitable non-surfactant-like foam inhibitors are organopolysiloxanes and mixtures thereof with microfine, optionally silanized silica, paraffins, waxes, microcrystalline waxes and mixtures thereof with silanized silica. Bis-acylamides derived from C₁₂-C₂₀ alkylamines and C₂-C₆ dicarboxylic acids may also be used. It is also of advantage to use mixtures of different foam inhibitors, for example mixtures of silicones and paraffins or waxes. The foam inhibitors are preferably bound to a granular water-soluble or water-dispersible carrier substance or are mixed with the plasticizer and/or lubricant.

The detergents may carry derivatives of diaminostilbene disulfonic acid or alkali metal salts thereof as optical brighteners. Suitable optical brighteners are, for example, salts of 4,4′-bis-(2-anilino-4-morpholino-1,3,5-triazinyl-6-amino)-stilbene-2,2′-disulfonic acid or compounds of similar structure which contain a diethanolamino group, a methylamino group, an anilino group or a 2-methoxyethylamino group instead of the morpholino group. Brighteners of the substituted 4,4′-distyryl-di-phenyl type may be present, for example the compound 4,4′-bis-(4-chloro-3-sulfostyryl)-diphenyl. Mixtures of the brighteners mentioned may also be used.

According to a further preferred embodiment of the invention uniform white granules are obtained if the detergent or cleaning agent, in addition to the usual optical brighteners in customary amounts, for example between 0.1 and 0.5, preferably 0.1 to 0.3 wt. %, contains even small amounts of a blue dye, such as 10⁻⁶ to 10⁻³ wt. %, preferably 10⁻⁵ wt. %. A particularly preferred dye is Tinolux® (product name of Ciba-Geigy).

Suitable enzymes are those from the class of proteases, lipases and amylases or mixtures thereof. Enzymatic active substances obtained from bacterial strains or fungi, such as Bacillus subtilis, Bacillus licheniformis and Streptomyces griseus, are particularly well suited.

Proteases of the subtilisin type and in particular proteases obtained from Bacillus lentus are preferably used. The enzymes may be adsorbed at carrier substances and/or embedded in enveloping substances in order to protect them against premature decomposition.

Suitable stabilizers, particularly for per compounds and enzymes, include the salts of polyphosphonic acids, in particular 1-hydroxyethane-1,1-diphosphonic acid (HEDP).

The detergents and cleaning agents can be produced uniformly from extrudates having the above-mentioned ingredients. However, the detergents and cleaning agents can also be obtained from a mixture of several different granulates of which the extrudates according to the invention form the main component. For example, the bleach activator, enzymes and dyes and fragrances can be added subsequently to the extrudates. It is preferred here for the bleach activator and the enzymes to be used in each case in compacted granular form, for example as separately produced extrudates obtained by means of a kneader of the above-described embodiment or on a pellet mill.

### Shape of the Detergent or Cleaning Product

In particular embodiments the washing and cleaning product passes the standard throat test.

In order to ensure child safety of washing and cleaning products, the standard throat test is used in accordance with European Standard 71-1 (modified version of the standard ISO 8124.1). The standard throat is a test cylinder, which has the size of a child's throat. The standard throat is usually used to test whether toys or small parts can be swallowed by infants under 3 years. The dimensions of the standard throat (in mm) are given in FIG. 5.

If the examined part fits completely into the cylinder it is considered ingestible and thus as not permissible for a toy of that age group. Thus it appears that parts having a width of 31.7 mm and a length of at least 31.7 mm must have a height (thickness) of 25.4 mm to pass the standard throat test. With a greater width, the height (thickness) may also be slightly smaller.

The detergent or cleaning agent product according to the invention will therefore preferably have a width of at least 32 mm, in particular from 32 to 40 mm, and more preferably from 33 to 38 mm, and a height of at least 25 to 30 mm, and more particularly 25 to 27 mm. The length of the detergent or cleaning agent product is flexible; by definition (and for safety reasons) the length, however, correspond at least to the width.

In the case of a cleaning agent for automatic dishwashing machines the maximum length is predefined by the size of the dosing chambers in the automatic dishwashers and therefore should not exceed 50 mm.

The detergent or cleaning agent product according to the invention is characterized by dimensional stability. The dimensional stability of the detergent or cleaning agent products with liquid unit doses can be defined via the constant weight during storage of the detergent or cleaning agent contained. A maximum constant weight during storage of the detergent or cleaning agent contained in the detergent or cleaning agent product is given when the pure detergent or cleaning agent (excluding the other constituents of the product) has the highest possible constant weight in the test described below: 50 mg of the detergent or cleaning agent (without products) are stored in an open aluminum crucible under isothermal conditions (40° C.) for several hours under purge gas (air, 3 l/h). At intervals of 30 minutes, the weight of the filled crucible is checked, and the residue of the detergent or cleaning agent or the weight loss determined.

Typically, the weight loss is highest in the first two hours of the specified test. Within the scope of the present invention, the term dimensional stability of the detergent or cleaning agent product means that the detergent or cleaning agent in the indicated test after 2 hours, preferably after 4 hours, has a weight loss of at most 15 wt. %. In particular, it is preferred that the weight loss after one hour is not above 10 wt. %. It is even more advantageous if the weight loss after 2 hours is not above 10 wt. %.

### A Method for Preparing a Washing or Cleaning Product

In a second aspect the present invention relates to a method for producing a detergent or cleaning agent product comprising the steps of:
providing at least one first layer which is a flexible, substantially water-soluble, substantially dry foam layer,
providing at least one second substantially water-soluble layer, forming at least one first chamber containing a unit dose of a liquid and/or solid detergent or cleaning agent, wherein
the second substantially water-soluble layer is preferably a substantially water-soluble film.

The term “providing” in the sense of the present invention means that a finished layer is introduced into the process of the present invention. In some embodiments the method also includes the formation of the film and the subsequent introduction into the process to produce the products according to the invention. Likewise, it is possible to form a layer only during the manufacture of the product. This means that, if necessary, a layer is formed and another layer is formed thereon.

The term “forming” in the sense of the present invention means that a layer or a chamber is embodied in accordance with the invention, that is to say is arranged in the product and is only prepared there in advance where appropriate.

In some embodiments of the method for producing a detergent or cleaning agent product, providing the at least one first chamber comprises forming the at least one first chamber between the at least one first and the at least one second layer by the at least one first and the at least one second layer.

In various embodiments of the method for producing a detergent or cleaning agent product, providing the at least one first chamber comprises forming the at least one first chamber by a first structure, wherein the first structure comprises the at least one first layer. In some variations, providing the at least one second layer comprises forming the at least one second layer such that it completely surrounds the first structure. In some embodiments providing the at least one second layer also comprises forming the at least one second layer and the third layer such that they are in direct contact with each other. In further embodiments the first structure comprises a third layer, which is a substantially water-soluble film, wherein the at least one first chamber is formed by the at least one second layer and the third layer. In particular embodiments the first structure consists of the at least one first layer.

In particular embodiments of the method for producing a detergent or cleaning agent product, providing the at least one first chamber comprises forming the at least one first chamber by a first structure, wherein the first structure comprises the at least one second layer. In some cases providing the at least one first layer comprises forming the at least one first layer such that it completely surrounds the first structure. In addition, in some embodiments, providing the at least one first layer comprises forming the at least one first layer and the first structure such that they are in direct contact with each other. In different embodiments the first structure comprises third layer, which is a water-soluble film, wherein the at least one first chamber is formed by the at least one first layer and the third layer. In some embodiments the first structure consists of the at least one second layer.

The term “contact” in the sense of the present invention, based on two layers, means that the two layers contact each other at least at one point.

“Establishment of contact” in the sense of the present invention means that a process step is applied which brings two layers into contact with each other.

“A method for establishing contact” in the sense of the present invention may be any suitable method by means of which the contact between two layers of the present invention can be established. In particular, such methods are selected from the group consisting of printing methods, adhesive methods, welding methods, and moistening pressing and drying of the layers between which contact is to be established.

In various embodiments of the method for producing a detergent or cleaning agent product the at least one second layer is transparent and formed such that the content of a first chamber is visible from the outside through the at least one second layer.

In some embodiments of the method for producing a detergent or cleaning agent product, the method comprises the establishment of contact between the at least one first and the at least one second layer, wherein the contact between the two layers is established by at least one method selected from the group consisting of printing methods, adhesive methods, welding methods, and moistening pressing and drying of the two layers.

Disclosure for producing products with detergent or cleaning agent products can be found in WO 2012/138820 A1, DE 69108526 T2 and DE P1287502.4-27. WO 2012/138820 A1 discloses in particular the production of foam layers. The disclosure of these documents is hereby incorporated by reference.

“Providing at least one first layer, which is a flexible, substantially water-soluble, substantially dry foam layer” comprises the production of the first layer, which is processed to form the detergent or cleaning agent product. In other words, this step comprises the production of a liquid solution of the foam constituents. This solution is foamed by suitable methods and then shaped and dried. The shaping includes casting the foamed solution in appropriate molds, which give the foam a predetermined shape. The first layer, which is a flexible, substantially water-soluble, substantially dry foam layer, can be produced in any desired form. This can be chosen freely depending on marketing, and shapes that appeal to the consumer can thus be chosen. The drying comprises drying methods, such as contact drying, hot air drying, vacuum drying, microwave drying and roller drying. Subsequently, the foam layer can be printed and/or brought into specific shapes by punching/cutting. Thus, small foam layers of particular design are produced. It is particularly effective to make long strips with a foam layer, to print them and/or to provide certain shapes of small foam layers by punching/cutting. The foam layers can also be embossed with certain characters such as logos, patterns and symbols. The foam layer can be individually adapted to the needs of consumers and/or marketing strategies.

“Forming at least one first chamber containing a unit dose of a liquid and/or solid detergent or cleaning agent” comprises the thermoforming of a first layer, overlaying with the unit dose of a liquid and/or solid detergent, and sealing of the chamber by a second layer, so that a tight chamber is produced, which contains the unit dose. As described above, the two layers may be joined together.

In particular embodiments the first layer, which is a flexible, substantially water-soluble, substantially dry layer, and the second layer, which is a substantially water-soluble film, are thermoformed together. The two layers are permanently connected to one another before, during or after the thermoforming. If the first and second layers are connected prior to thermoforming, the orientation of the two layers is arbitrary. If the two layers are connected to one another during thermoforming or thereafter, it is advantageous and preferred if the first layer is oriented downwardly, toward the vacuum. Subsequently, the first and the second layer can be covered with the unit dose of a detergent or cleaning agent. The at least one first chamber is formed, in particular embodiments, by a third layer, which is a substantially water-soluble film. Here, the third and the second and, if applicable, the first layer are connected to one another as described herein.

In various embodiments of the method for producing a detergent or cleaning agent product the detergent or cleaning agent product is a detergent or cleaning agent product according to the first aspect of the present invention. Therefore, the disclosure in respect of the embodiment of the detergent or cleaning agent product also belongs to the disclosure of the claimed method.

In a third aspect the present invention relates to a detergent or cleaning agent product obtainable by a method according to the second aspect of the present invention.

### Container Containing the Washing or Cleaning Product

In a fourth aspect, the present invention relates to a container that contains a detergent or cleaning agent product according to the first aspect or third aspect of the present invention.

A detergent or cleaning agent product according to the present invention may be stored in a sealable container and the interior of the closed container may thus be scented.

The sealable container is usually designed to accommodate a plurality of water-soluble packagings.

A container in the sense of this application is a device which is intended to encase a plurality of detergent or cleaning agent products such that they can be shipped, stored and/or marketed.

The container usually has a base and a lateral surface, by which an interior space for receiving the detergent or cleaning agent product is formed. The container also regularly has an opening to remove the detergent or cleaning agent products from the container, wherein the opening can be closed by a closure.

The container is especially designed such that in the closed state there is no fragrance released from the container takes into the environment.

The container for receiving the detergent or cleaning agent product preferably has the lowest possible water vapor permeability to protect the detergent or cleaning agent product stored therein against undesired exposure to water vapor.

The container is formed in accordance with a first preferred embodiment as a dimensionally stable container, for example in the form of a closed box, can, bottle or carton.

It is also possible in principle to shape the container as a non-dimensionally stable container, for example as a pouch or bag. It is particularly advantageous in this context to embody the non-dimensionally stable container as a stand-up pouch. The container is preferably formed from a plastic. It is also possible to form the container from a cellulose-containing material such as paper, cardboard or paperboard. Of course, the container may be made also of multi-layer materials comprising plastics, cellulose-containing materials and/or metallic materials. Here, composite materials consisting of a cellulose-containing substrate material, which is laminated with plastics film and/or metallic foil can be used.

### Use of the Detergent or Cleaning Agent Product

In a fifth aspect the present invention relates to the use of a detergent or cleaning agent product according to the invention as a detergent or dishwashing detergent. In some embodiments the detergent or cleaning agent product of the present invention is used for washing clothes. In further embodiments the detergent or cleaning agent product of the present invention is used for dishwashing.

### GENERAL DEFINITIONS

All documents cited herein are hereby incorporated in their entirety by reference. The inventions illustratively described herein may be implemented suitably in the absence of any element or elements, limitation or restrictions which are not specifically disclosed herein. For example, the terms “comprising”, “including”, “containing”, etc. can be interpreted broadly and without restriction. Additionally, the terms and expressions are used only for description and not for limitation, and there is no intention with the use of such terms and expressions to exclude any equivalents of the shown and described features or parts thereof, but it is clear that various modifications within the scope of the claimed invention are possible. Thus, it is understood that, although the present invention is specifically disclosed with reference to preferred embodiments and optional features, modifications and variations of the inventions, a person skilled in the art can revert to these and can develop new modifications and variants that lie within the scope of the present invention. The invention has been described broadly and generically. Each of the narrower species and sub-groups that fall within the general disclosure are also part of the invention. This includes the generic description of the invention with a proviso or negative limitation that excludes items of the genus, regardless of whether the cut material is indicated herein specifically. In cases where features or aspects of the invention in the form of Markush groups are described, a person skilled in the art will recognize that the invention is thus also described in terms of each individual member or subgroup of members of the Markush group. Further embodiments of the invention will become apparent from the following claims.

### Examples

Calculation of the moduli of elasticity in simple tensile test:

Measurements of the moduli of elasticity are taken with the “TA.XTplus Texture Analyser” apparatus from Stable Micro Systems.

### Setting Texture Analyser:

Simple tensile test, path total: 60 mm, speed: 1 mm/s

### Preparation and Measurement

Cut test specimens to size, determine length, width and breadth.
Clamp the specimen and perform the test.
Calculation of strain
Ascertain the respective length change from the measurement diagram of 3 different force points. Determine the strain by dividing the respective change in length by the total length of the test specimen The total length of the test specimen begins and ends where the body is clamped in the apparatus in the unstretched condition.
Calculation of stress
Determine the cross-sectional area from width×breadth of the test specimen. Determine the stress by dividing the respective force point by the cross-sectional area.
Calculation of the modulus of elasticity
Determine the modulus of elasticity by dividing the respective stress by the respective strain. If the modulus of elasticity is linear, the measured values for the respective 3 force points match in an ideal scenario.
Moduli of elasticity (E) of solid foams (stress-strain-diagram)
Calculation example

Test Material: PVA Foam

Test specimen: length 100 mm, width 7 mm, breadth 10 mm

E=modulus of elasticity, c=strain (dimensionless), ΔI=change in length [mm], I0=original length [mm], σ=mechanical stress [pressure, Newton/mm²], F=force [Newton], A=area [width×breadth, mm²].

| Formulas | Change in length | Expansion [dimensions] |
|---|---|---|
| $E = \frac{σ}{ɛ}$ | [symbol] = 102.027 mm − 100 mm = 2.027 mm | $ɛ 1 = \frac{2.027 mm}{100 mm} = 0.02027$ |
| $ɛ = \frac{Δ 𝓁}{𝓁 0}$ | [symbol] = 104.843 mm − 100 mm = 4.843 mm | $ɛ 2 = \frac{4.843 mm}{100 mm} = 0.04843$ |
| [symbol] = [symbol] − [symbol] | [symbol] = 106.26 mm − 100 mm = 6.26 mm | $ɛ 3 = \frac{6.26 mm}{100 mm} = 0.0626$ |
| $σ = \frac{F}{A}$ | | |

Calculation of Stress

### Force [Newton]

### F1=1 Newton 1: 100 g/1 Newton/2.027 mm

### F2=2 Newton 2: 200 g/2 Newton/4.843 mm

### F3=2.5 Newton 3: 250 g/2.5 Newton/6.26 mm

The application was performed as shown in FIG. 4.

| Area [width × breadth mm²] | |
|---|---|
| A 1 to 3 = 7 mm × 00 mm = 70 mm² | Calculation of moduli of elasticity |
| Mechanical stress [pressure, Newton/mm²] | Modulus of elasticity [mega pascal MPa] |
| $σ 1 = \frac{1 Newton}{70 mm 2} = 0.01428571$ | $E 1 = \frac{0.014286 Newton}{0.020270 mm 2} = 0.704700 [ MPa ]$ |
| $σ 2 = \frac{2 Newton}{70 mm 2} = 0.02857143$ | $E 2 = \frac{0.028571 Newton}{0.048430 mm 2} = 0.589942 [ MPa ]$ |
| $σ 3 = \frac{2.5 Newton}{70 mm 2} = 0.03571429$ | $E 3 = \frac{0.035714 Newton}{0.062600 mm 2} = 0.57051118 [ MPa ]$ |

E mean value = 0.621717 [MPa]

Method for producing a detergent or cleaning agent product, in particular pouches:

1. Preparation of a Higher-Viscosity, Preferably Aqueous Solution of the Ingredients of the Foam

(similarly to WO 2012/138820, the disclosure of which is incorporated herein by reference):
Produce a premix comprising from about 1 to about 75 wt. % of surfactant, from about 0.1 to about 25 wt. % of water-soluble polymer, from about 0.1 to about 75 wt. % of water and optionally from about 0.1 to about 25 wt. % of softener, wherein the premix has: a viscosity at 1 s⁻¹ and 70° C. from about 1,000 cps to about 20,000 cps; and wherein the premix is heated to a temperature in the range from about 60° C. to about 90° C. The viscosity of the premix is s determined by a Brookfield RVDV-1 Prime viscometer with a CPE-41 cone and at a shear rate of 1 s⁻¹ with a period of 300 s. The premix is preferably produced in an inline dispersing system. An exemplary, non-limiting composition for the manufacture of a foam layer is as follows:

| Composition of PVA foam | Formula | Mass |
|---|---|---|
| Mowiol 4-88 | 9% | 900 g |
| Mowiol 18-88 | 5% | 500 g |
| Texapon N70 | 10% | 1000 g |
| Glycerol 99% | 5% | 500 g |
| Dist. water | 71% | 7100 g |
| Total | 100% | 10000 g |

2. Foaming of the Premix (Similarly to WO 2012/138820):

Aerate the premix by introducing a gas into the premix to form a wet, aerated premix, wherein the wet, aerated pre-mix has a density from about 0.15 to about 0.65 g/ml.

To aerate the premix a dynamic foam generator for continuous foaming can be used. For example, the devices of the company Hansa Industrie-Mixer GmbH & CO. KG, Kronsbruch 6-8, 28816 Heiligenrode, www.hansamixer.de. Based on the rotational speed of the foam generator, the aeration and thus the foam density can be controlled.

3. Dispensing the foam from step 2 and drying to form a flexible, substantially dry, substantially water-soluble foam layer. For example, treating the wet, aerated premix by means of doctor blade technique to form one or more layers on a tape; and drying the layers, for example in a drying cabinet to form the dry foam. The residual moisture of the foam is 10 wt. % or less.

4. Simultaneous thermoforming of a flexible, substantially water-soluble, substantially dry foam layer (step 1-3) and a water-soluble PVA film, wherein the foam layer is below the PVA film (for example Mono-Sol M8630 films 90u, M8630 76u or M8630 88u). Connecting the foam layer to the PVA film (may be performed prior to thermoforming). Coating the two layers with a unit dose of a liquid detergent or cleaning agent. Alternatively: applying a unit dose of a solid cleaning agent or detergent. Covering the assembly of the cleaning agent and the two layers with a second water-soluble PVA film (for example Mono-Sol M8630 90u, M8630 76u or M8630 88u). Connecting the second PVA film to the first PVA film and, if necessary, the foam layer to form a sealed chamber containing the unit dose of the detergent or cleaning agent. The result is a substantially water-soluble, sealed washing or cleaning product.

Information regarding the thermoforming and filling of products with detergent or cleaning agents can be found in DE 69108526 T2 and DE P1287502.4-27. The disclosure of these publications is hereby incorporated by reference.

The detergent or cleaning agent product thus produced demonstrates good solubility in water and good washing or cleaning performance in a washing machine or dishwasher. The product fits well in the hand and is comfortable to hold.

A method for determining the water-solubility and dispersion of films and detergent or cleaning agent products

A film or a detergent or cleaning agent product with/or without content is clamped in a clamping apparatus, preferably a 35 mm slide frame.

A 600 ml beaker is filled with 500 ml of distilled water. The water is stirred by a 5 cm floating stirrer, the stirring speed is increased until a vortex is formed which reaches a height of about one fifth of the total water level. The temperature is then set to the predetermined value, for example 10° C. or 23° C.

The clamping apparatus, for example the slide frame, is fixed preferably by means of a fixed alligator clip and is kept in the beaker such that the long end of the clamping apparatus is parallel to the water surface and the alligator clip is approximately 0.6 cm below the water line. The clamping apparatus is held so that it extends—seen from above—approximately to the middle of the beaker.

Once the clamping apparatus has been introduced into the beaker, the time is measured until the film or the detergent or cleaning agent product with/or without content tears. Secondly, the time is measured that it takes for the film or the detergent or cleaning agent product with/or without content is disintegrated into separate parts as well as the time taken until all film fragments have dissolved in the water.

After a maximum of 300 seconds, the test is aborted. The test is repeated three times and then averaged.

For films that can be used in accordance with the invention it was determined that the film requires for example a time of ≦7 seconds in order to tear in the slide frame. Furthermore, a time of <70 seconds was determined for a film that can be used in accordance with the invention in order for said film to enter into solution, wherein a slide frame was used as clamping apparatus. In some embodiments the time for disintegration was <100 s and/or the time for complete dissolution was <300 s at 23° C.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A detergent or cleaning agent product comprising:
a) at least one first layer, which is a flexible, substantially dry, substantially water-soluble foam layer,
b) at least one first chamber, and
c) at least one second substantially water-soluble layer,
wherein the at least one first chamber contains a unit dose of a liquid and/or solid detergent or cleaning agent, wherein the at least one second layer is preferably a substantially water-soluble film.

2. The detergent or cleaning agent product as claimed in claim 1, wherein
a) the at least one chamber is arranged between the at least one first and the at least one second layer and is formed by the at least one first and the at least one second layer, or
b) the at least one first chamber is formed by a first structure comprising the at least one first layer, or
c) the at least one first chamber is formed by a first structure which comprises the at least one second layer.

3. The detergent or cleaning agent product as claimed in claim 2, wherein
in case b) the at least one second layer surrounds the first structure completely and/or
in case b) the at least one second layer and the first structure are in direct contact with each other or
in case c) the at least one first layer surrounds the first structure completely and/or
in case c) the at least one first layer and the first structure are in direct contact with each other.

4. The detergent or cleaning agent product as claimed in claim 2, wherein
in cases b) and c) the first structure comprises a third layer which is a substantially water-soluble film, which in case b) forms the at least one first chamber with the at least one first layer and in case c) forms the at least one first chamber with the at least one second layer or
in case b), the first structure consists of the at least one first layer or
in case c) the first structure consists of the at least one second layer.

5. The detergent or cleaning agent product as claimed in claim 1,
a) wherein the at least one second layer is transparent and is arranged such that the content of the at least one first chamber is visible from the outside through the at least one second layer and/or
b) wherein the flexible, substantially dry, substantially water-soluble foam layer, constituting the at least one first layer, comprises foamed substantially water-soluble polyvinyl alcohol and/or foamed substantially water-soluble polyvinylpyrrolidone and/or foamed substantially water-soluble copolymers thereof, and/or
c) wherein the at least one second substantially water-soluble layer is a substantially water-soluble polymer film and/or
d) wherein the at least one second substantially water-soluble layer is a flexible layer and/or
e) wherein the at least one second substantially water-soluble layer consists of a substantially water-soluble polymer film, consisting substantially of substantially water-soluble polyvinyl alcohol and/or substantially water-soluble polyvinylpyrrolidone, and/or substantially water-soluble copolymers thereof and/or
f) wherein in case b) and/or e) the substantially water-soluble polyvinyl alcohol and/or the substantially water-soluble polyvinylpyrrolidone and/or the substantially water-soluble copolymers thereof of the at least one first layer and/or of the at least one second layer have an average chain length of 600 to 12,000, and/or
g) wherein the flexible, substantially water-soluble, substantially dry foam layer of the at least one first layer comprises at least one constituent which is selected from the group consisting of a surfactant, softener, perfume, perfume delivery system, dye, preservative, bittern, filler, excipient, special polymer and a functional additive, wherein the surfactant is selected from the group consisting of nonionic, cationic, anionic, and amphoteric surfactants and mixtures thereof, the softener is selected from the group consisting of glycerol and polyols, the excipient is selected from the group consisting of thickeners and salts, the special polymer is selected from the group consisting of acrylic acid (co)polymer, cationic hydroxymethyl cellulose, carboxymethyl cellulose and HPMC, and the functional additive is selected from the group consisting of silicone oils, bentonites, perfume capsules, enzymes and bleaches, wherein the bleach is selected from the group of peroxy acids and amides of various peroxy acids, and/or
h) wherein the detergent or cleaning agent product is substantially water-soluble.

6. The detergent or cleaning agent product as claimed in claim 1, wherein
the detergent or cleaning agent product comprises at least one second chamber comprising a unit dose of a solid and/or liquid detergent or cleaning agent, wherein
a) the at least one second chamber is preferably configured similarly to the at least one first chamber as claimed in one of claims 1-5 and/or
b) the at least one first chamber contains a unit dose of a liquid detergent or cleaning agent and/or
c) the at least one second chamber contains a unit dose of a solid detergent or cleaning agent.

7. A method for producing a detergent or cleaning agent product, comprising the following steps:
providing at least one first layer, which is a flexible, substantially water-soluble, substantially dry foam layer,
providing at least one second substantially water-soluble layer,
forming at least one first chamber, which contains a unit dose of a liquid and/or solid detergent or cleaning agent, wherein
the second substantially water-soluble layer is preferably a substantially water-soluble film.

8. The method for producing a detergent or cleaning agent product as claimed in claim 7, wherein
a) providing the at least one first chamber comprises forming the at least one first chamber between the at least one first and the at least one second layer by the at least one first and the at least one second layer, or
b) providing the at least one first chamber comprises forming the at least one first chamber by a first structure, wherein the first structure comprises the at least one first layer, or
c) providing the at least one first chamber comprises forming the at least one first chamber by a first structure, wherein the first structure comprises the at least one second layer.

9. The method for producing a detergent or cleaning agent product as claimed in claim 8, wherein
in case b) the at least one second layer is provided such that the at least one second layer is formed such that it completely surrounds the first structure or
in case c) the at least one first layer is provided such that the at least one first layer is formed such that it completely surrounds the first structure.

10. The method for producing a detergent or cleaning agent product as claimed in claim 8, wherein
in case b) the at least one second layer is provided such that the at least one second layer and the first structure are formed such that they are in direct contact with each other or
in case c) the at least one first layer is provided such that the at least one first layer and the first structure are formed such that they are in direct contact with each other.

11. The method for producing a detergent or cleaning agent product as claimed in claim 8, wherein
in cases b) and c) the first structure comprises a third layer, which is a substantially water-soluble film, wherein in case b) the at least one first chamber is formed by the at least one second layer and the third layer, and wherein in case c) the at least one first chamber is formed by the at least one first layer and the third layer or
in case b) the first structure consists of the at least one first layer or
in case c) the first structure consists of the at least one second layer.

12. The method for producing a detergent or cleaning agent product as claimed claim 7, wherein
a) the at least one second layer is transparent and is formed such that the content of the at least one first chamber is visible from the outside through the at least one second layer and/or
b) the method comprises the establishment of contact between the at least one first and the at least one second layer, wherein the contact between the two layers is established by at least one method selected from the group consisting of printing methods, adhesive methods, welding methods, and moistening pressing and drying of the two layers and/or
c) the detergent or cleaning agent product is a detergent or cleaning agent product as claimed in one of claims 1-6.
